(19) United States
(12) Patent Application Publication
(10) Pub. No.: US 2003/0057343 A1
(43) Pub. Date: Mar. 27, 2003

(54) Book* reclining & viewing support

(76) Inventor: Reed Taft Jacobs, Salt Lake City, UT (US)

Correspondence Address: Reed Taft Jacobs, P.O. Box 520066, Salt Lake City, UT, 84152, US

(21) Appl. No.: 10/176,850

(22) Filed: Jun. 20, 2002

Related U.S. Application Data
(60) Provisional application No. 60/299,503, filed on Jun. 20, 2001.

(51) Int. Cl. A47B 19/00; B42D 9/00

(52) U.S. Cl. 248/441.1; 281/45; 281/42; 248/459

(57) ABSTRACT

A refined, simplified, cost-effective, and convenient method for stabilizing books, and bound materials at an angular displacement from a generally horizontal supporting surface, particularly to assist students, and those performing intense study—so as to synergistically optimize the visual image thereof on the appropriate visual receptors; and also to help relieve physical tension therefrom. The method involves manipulation of appropriate portions of the bookcover, or cover assembly, and/or interfacing other appropriate reclining support means of various sorts, which can closely, or smoothly mimic the structural, and usage profile of the bound items, and which interface with, and/or attach thereto. A “profile exception” is made for the interfacing of common items of various sorts, which students, or other bookreaders might naturally carry with them, including sports gear, or equipment, toys, pillows, cases, containers, and the like—many of which may be inflatable, or expandable in order to accomplish the angular stabilization function.

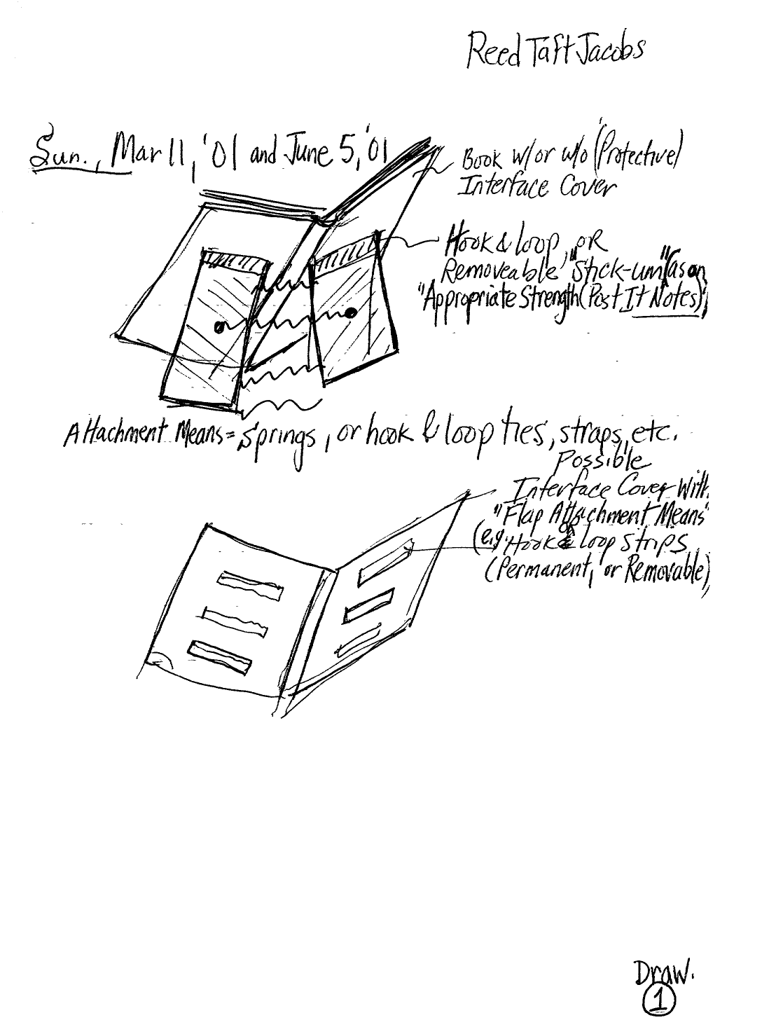

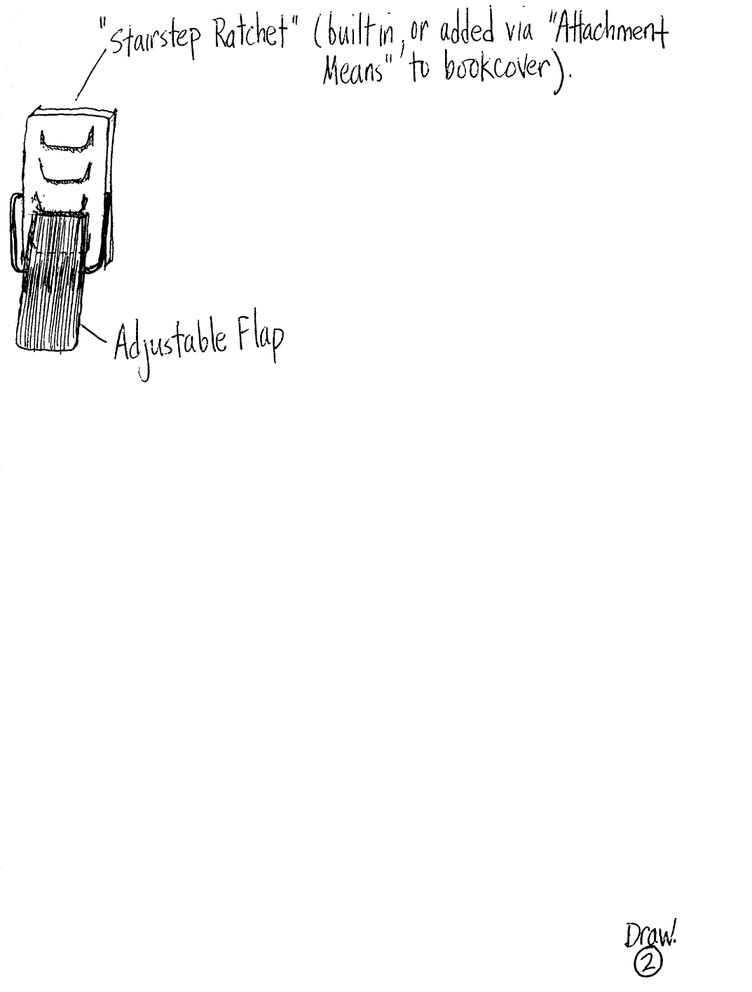

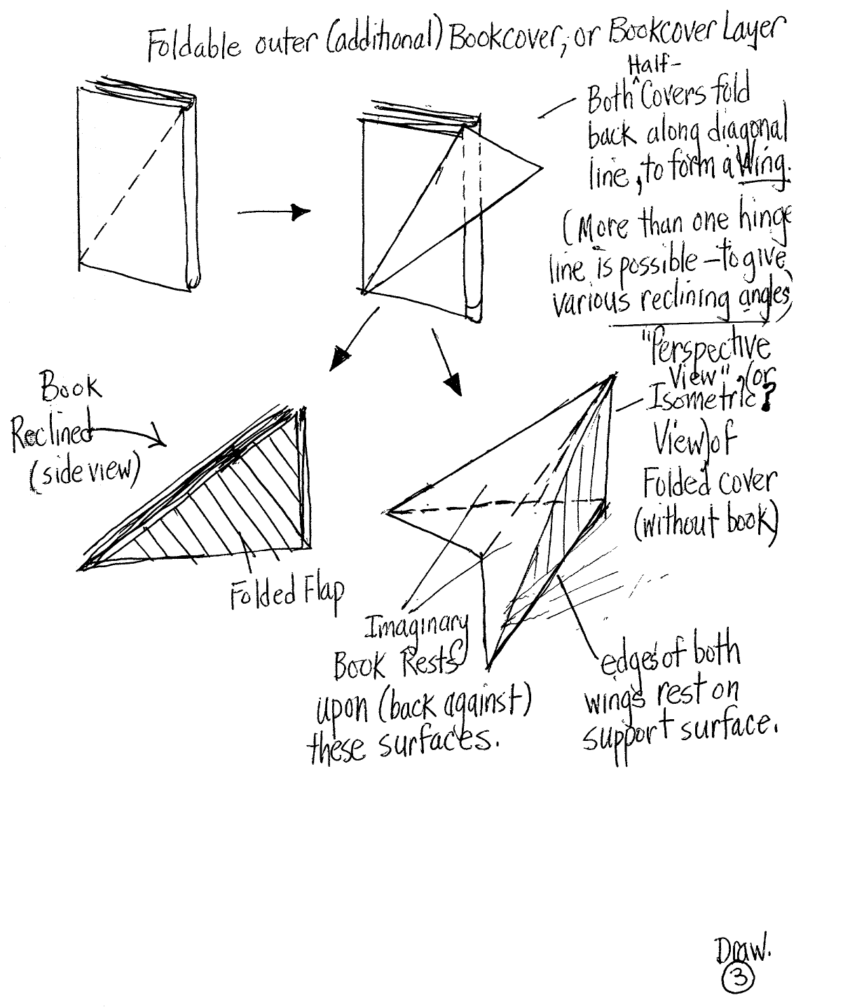

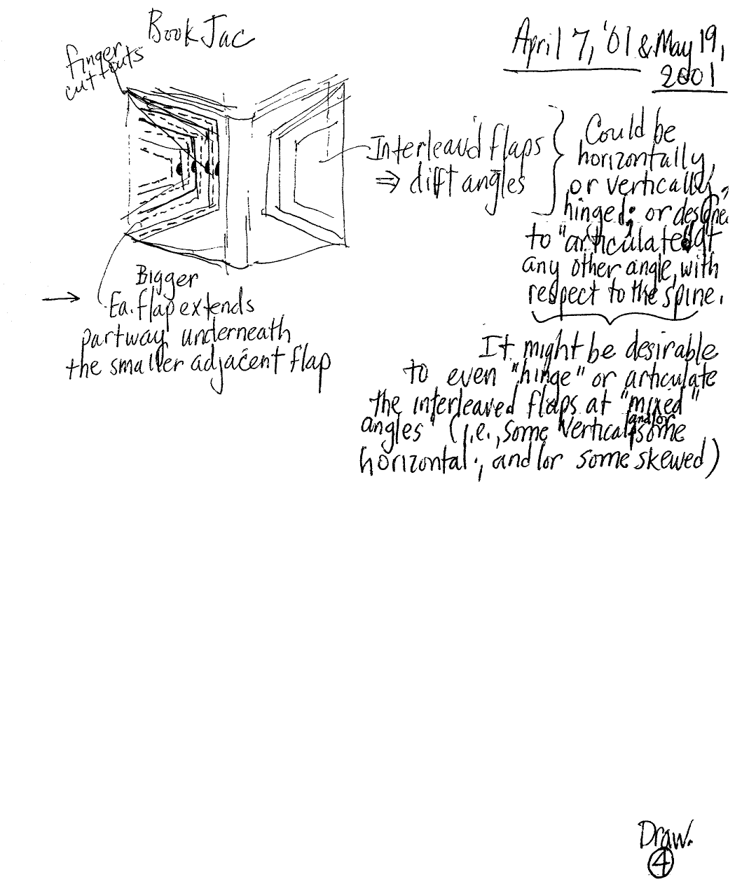

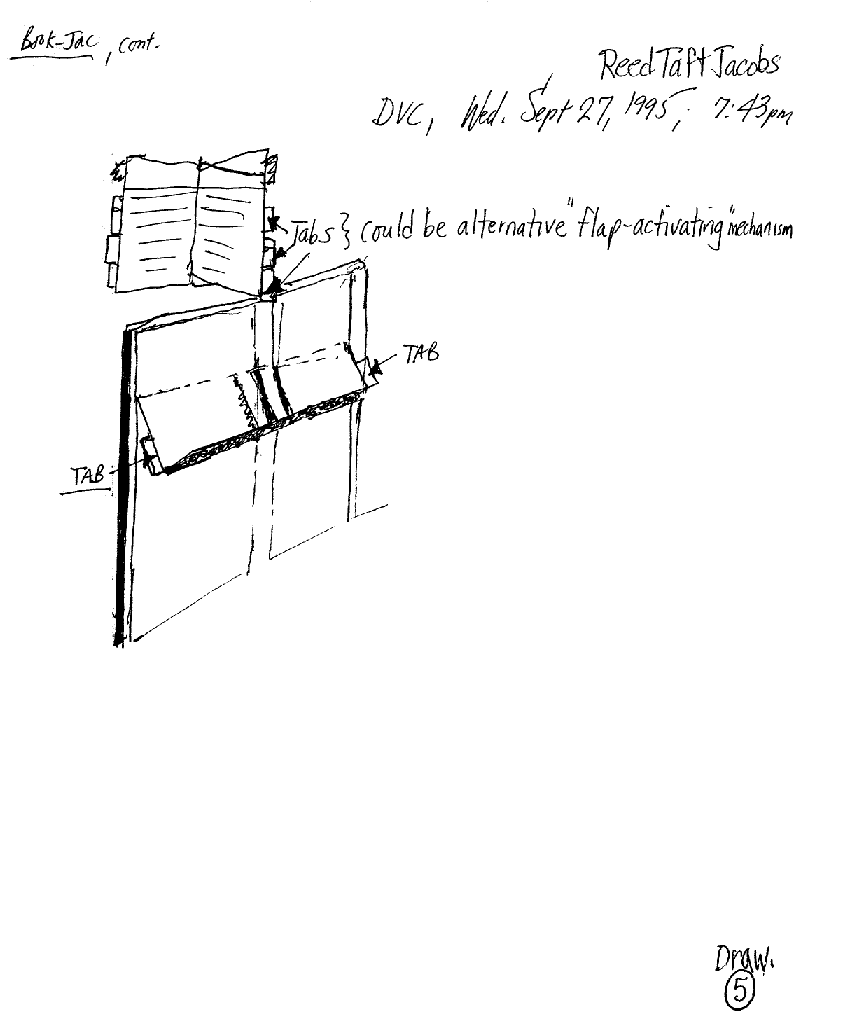

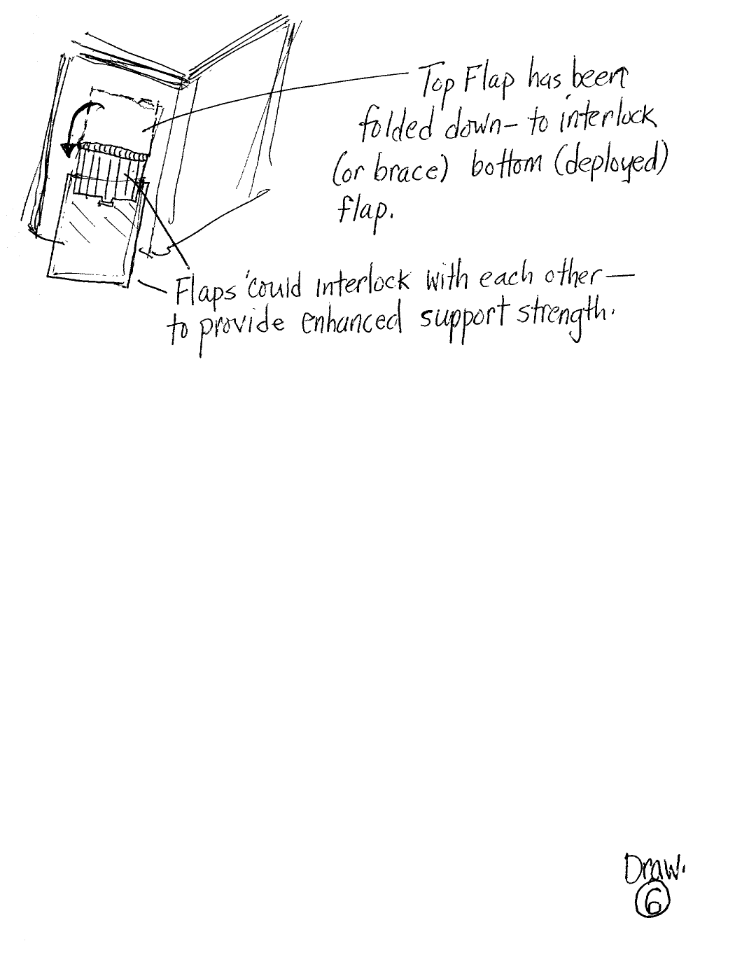

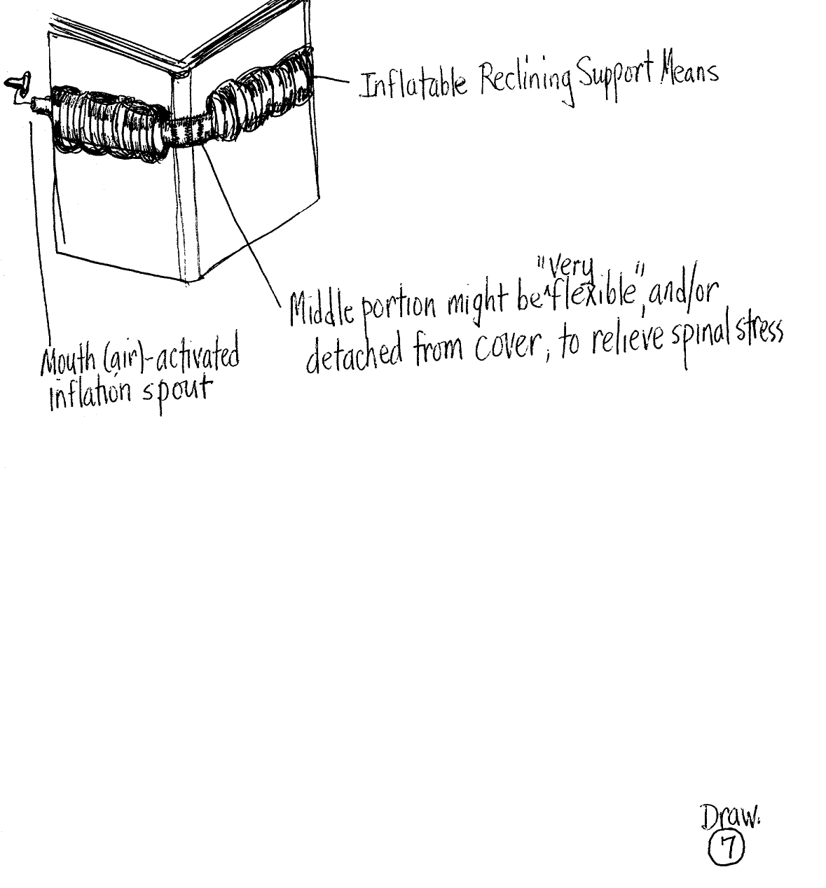

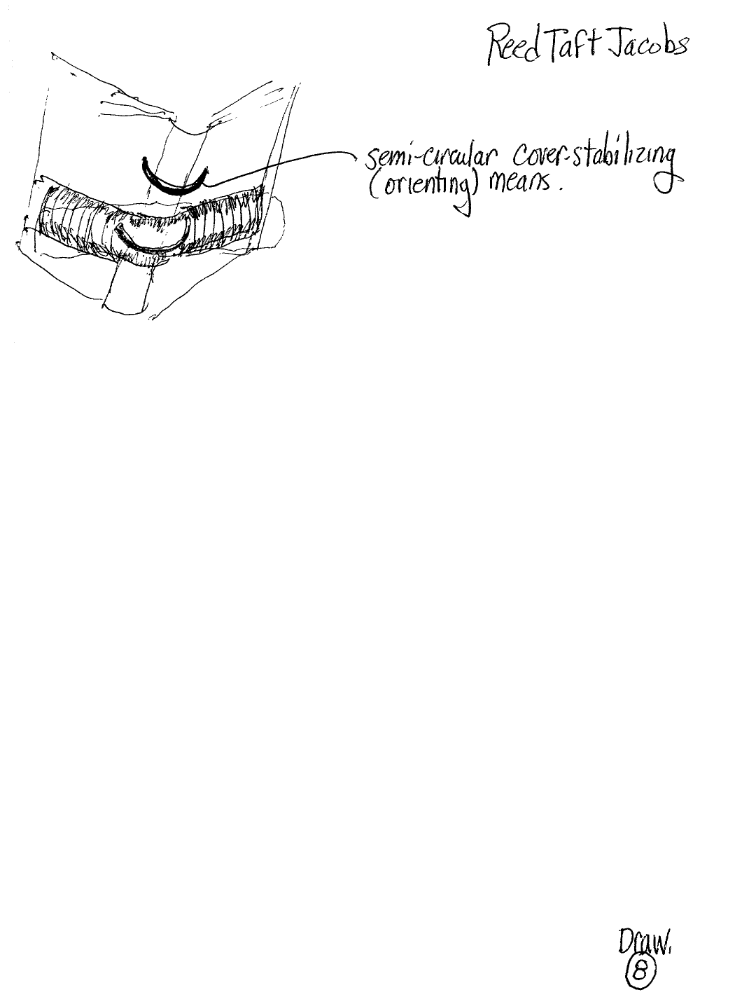

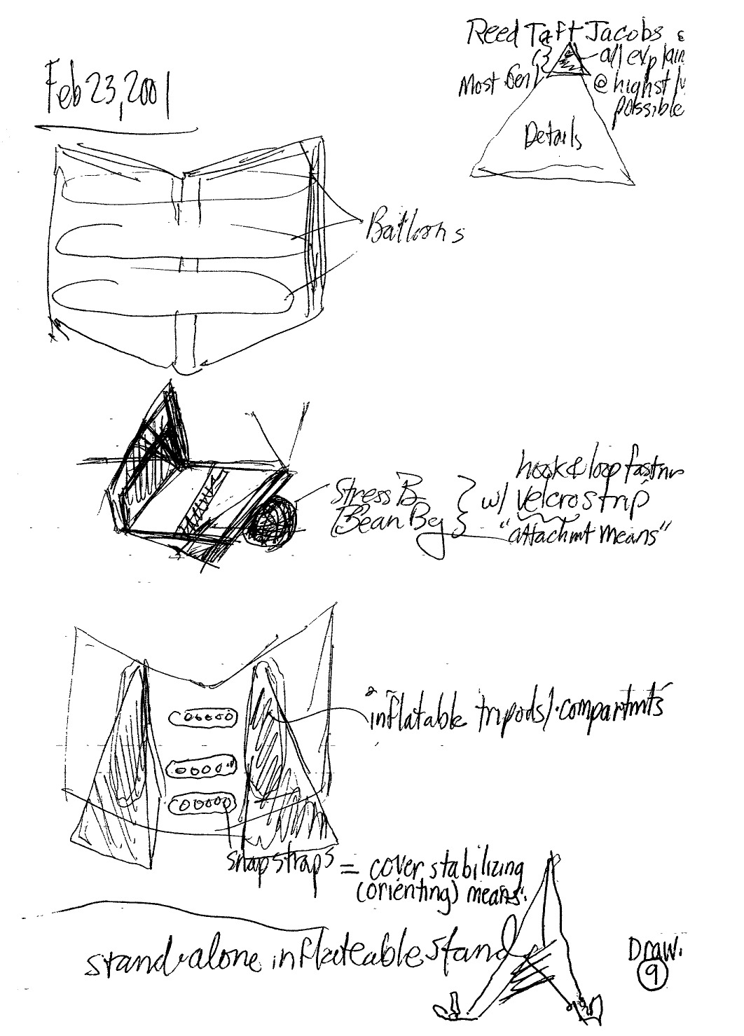

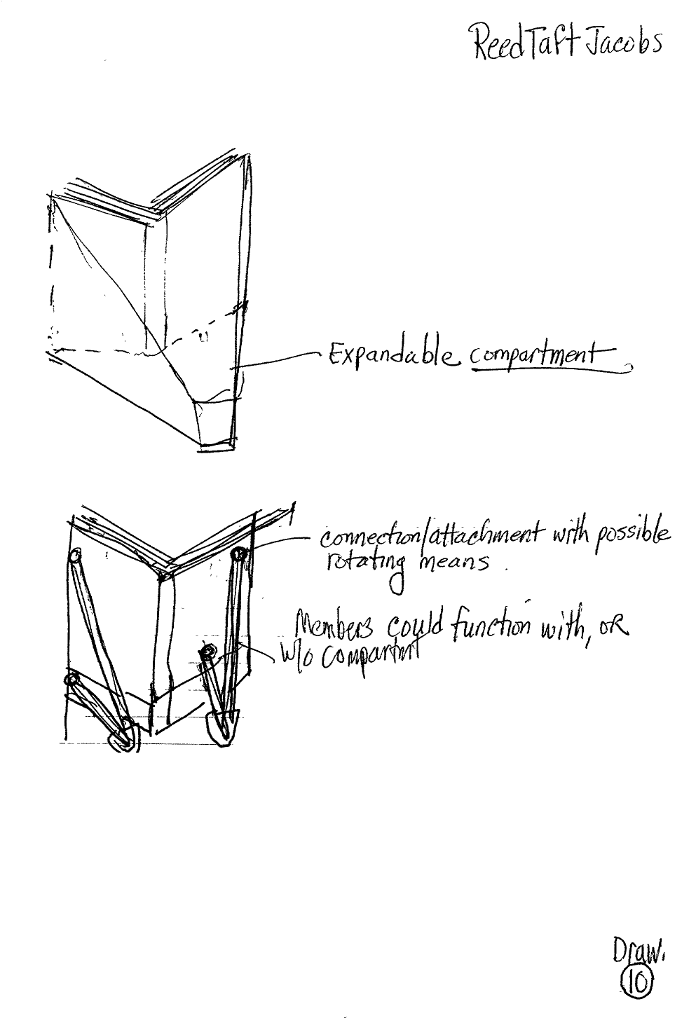

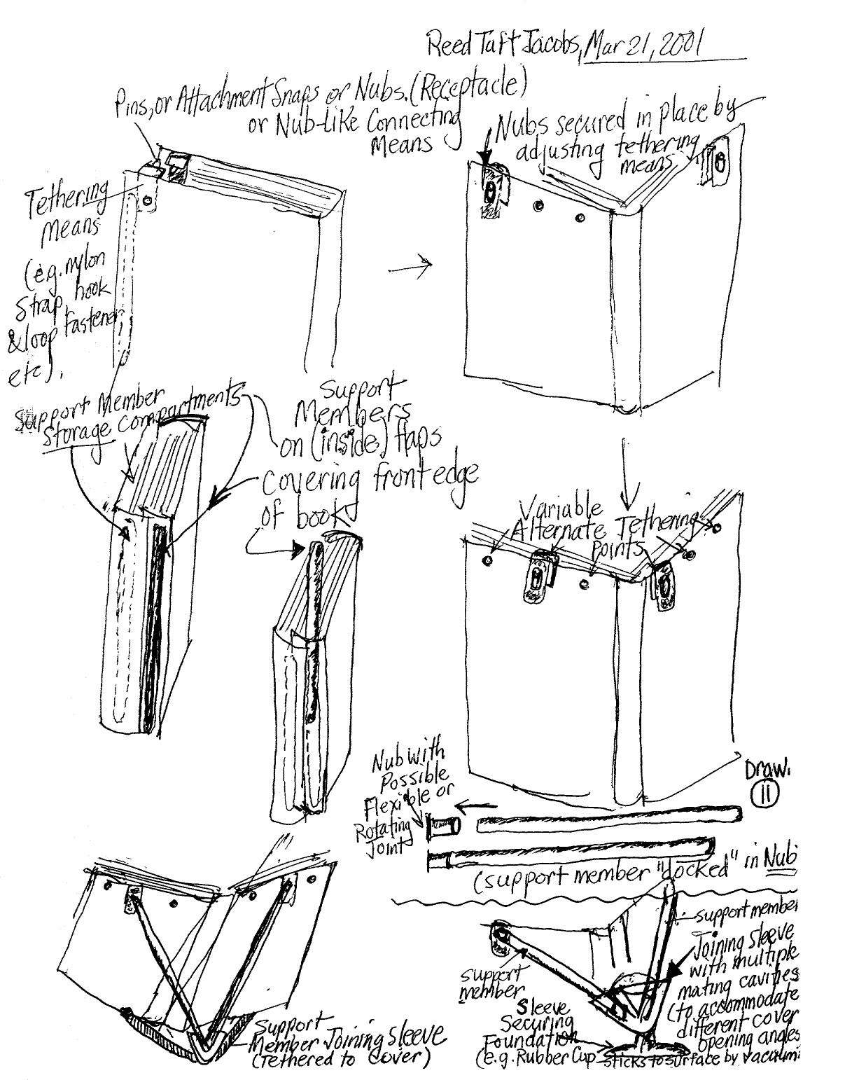

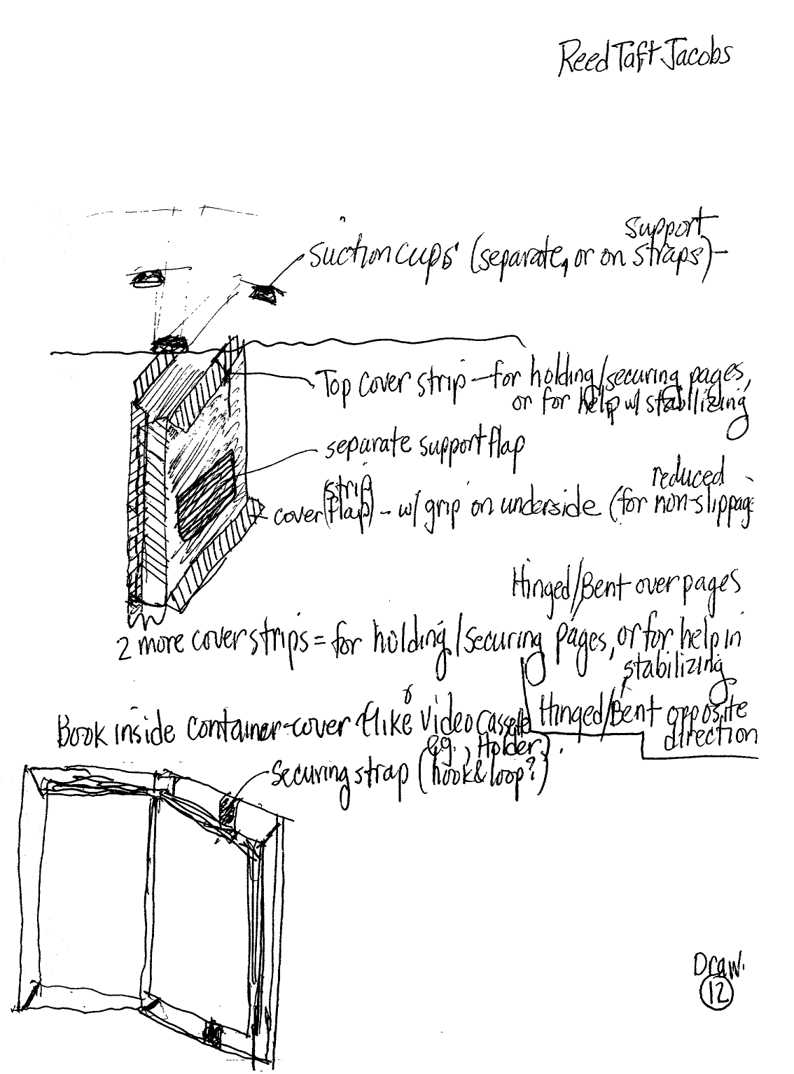

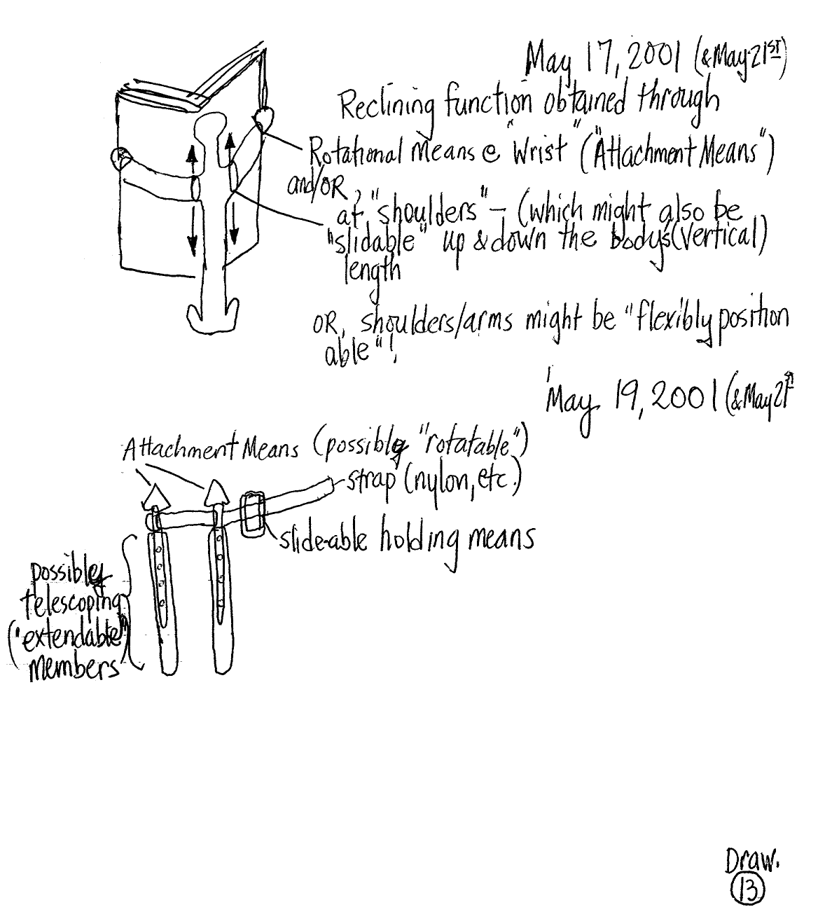

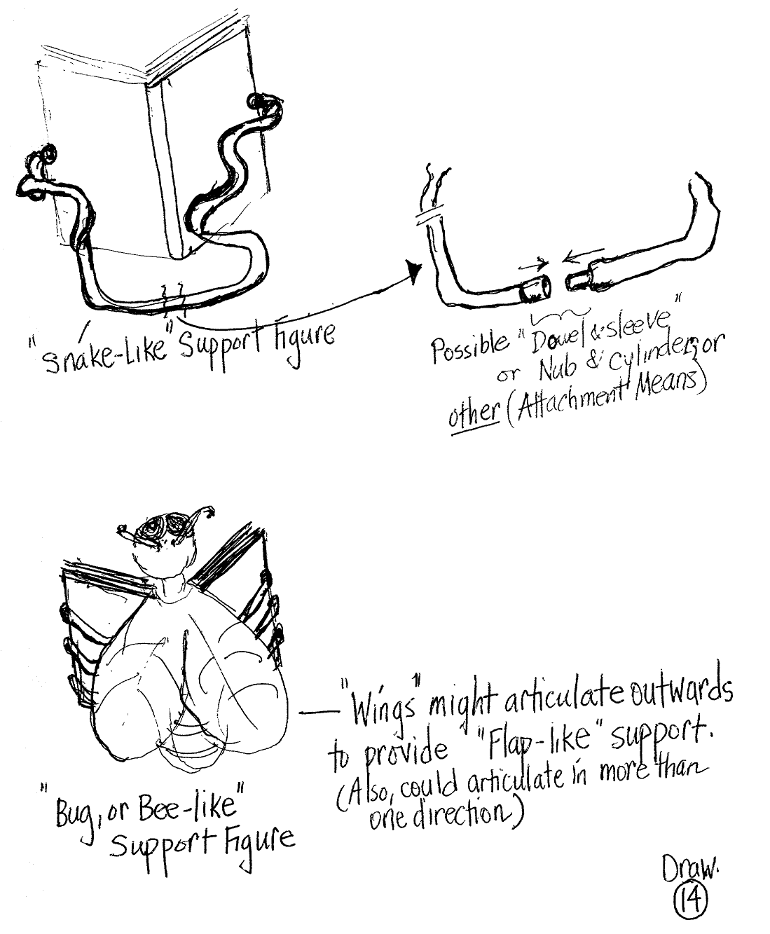

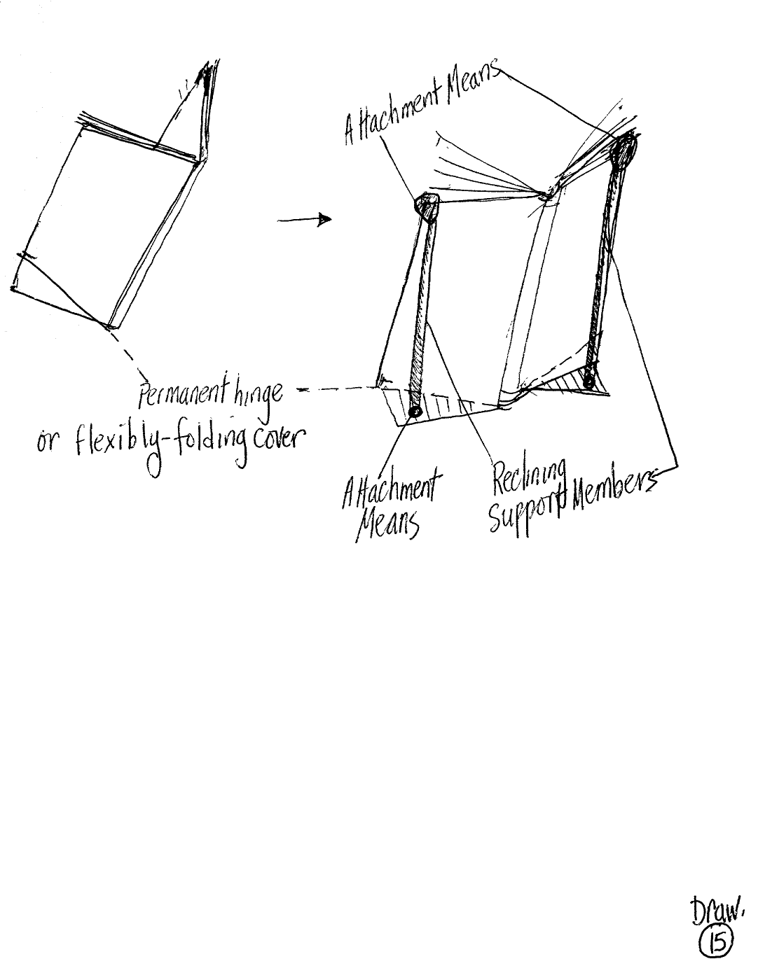

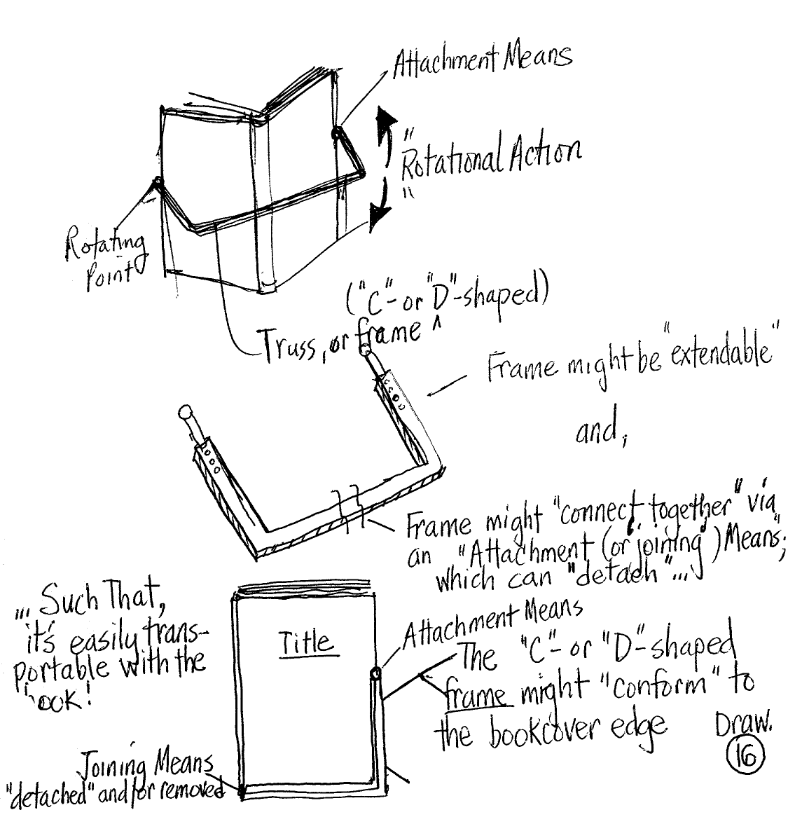

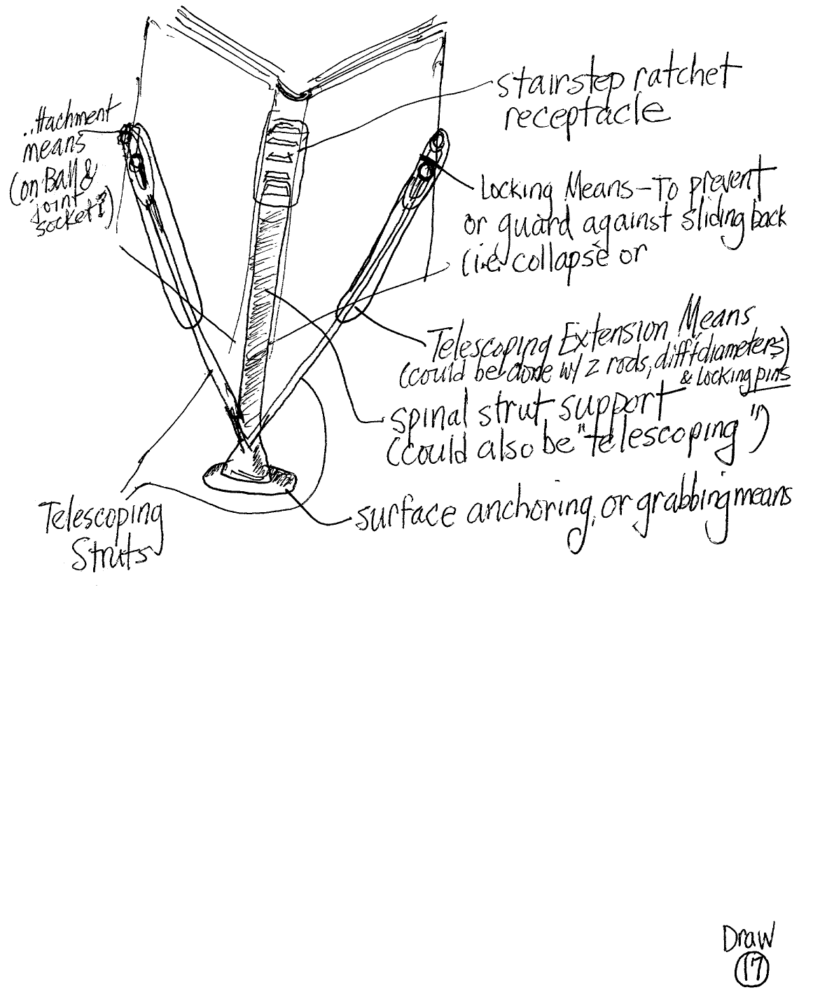

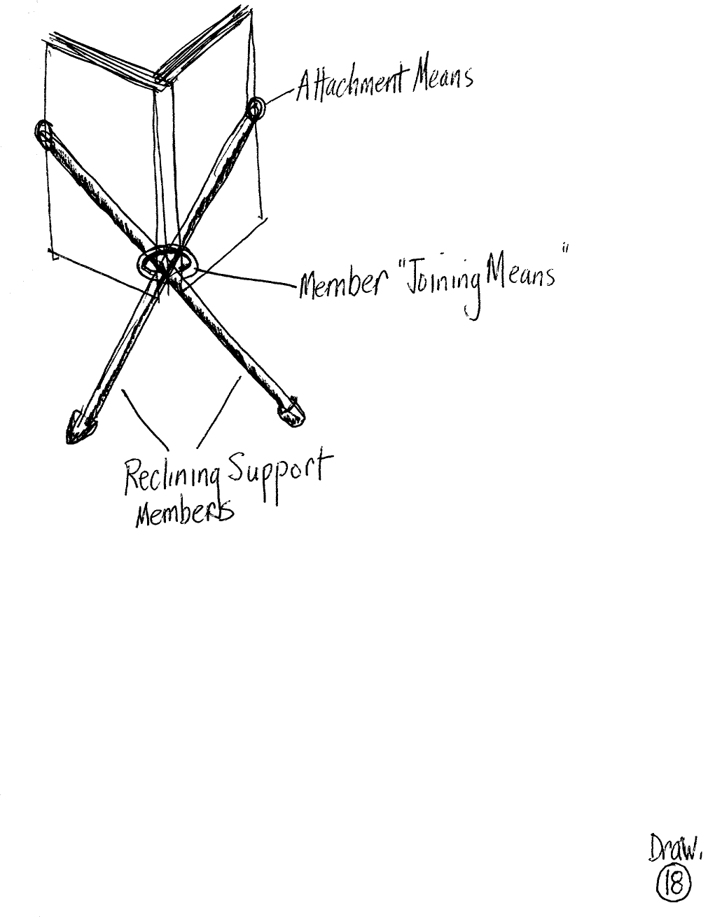

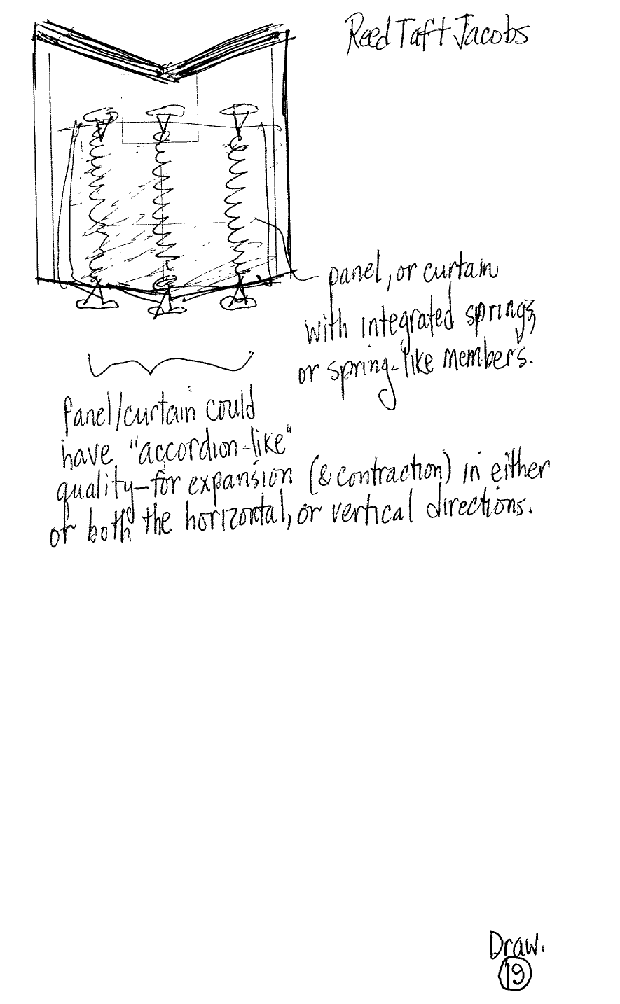

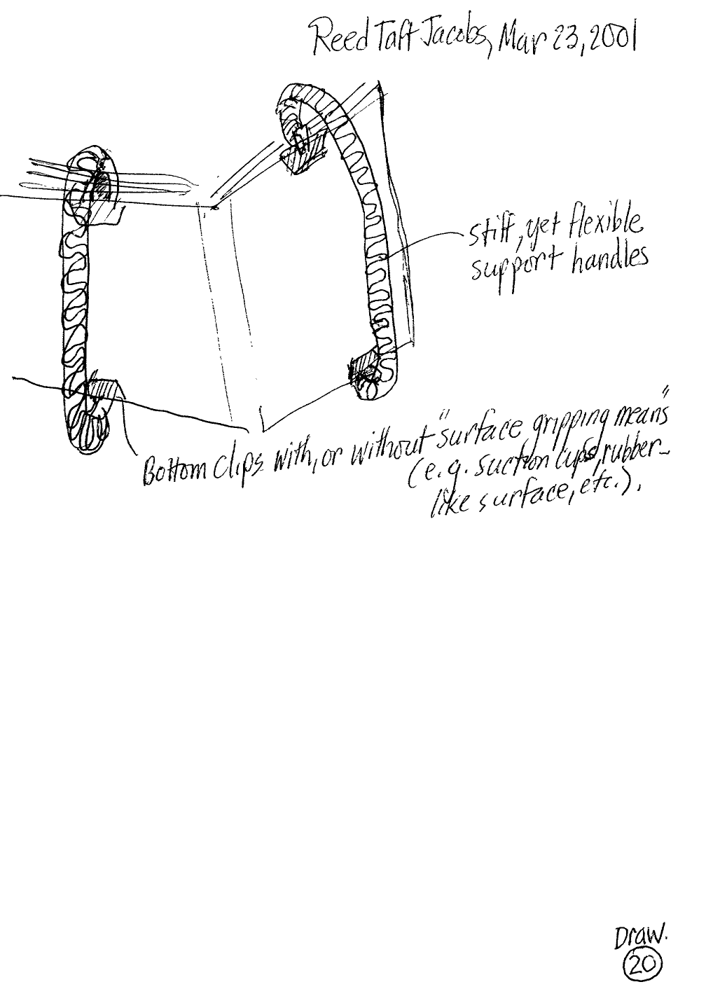

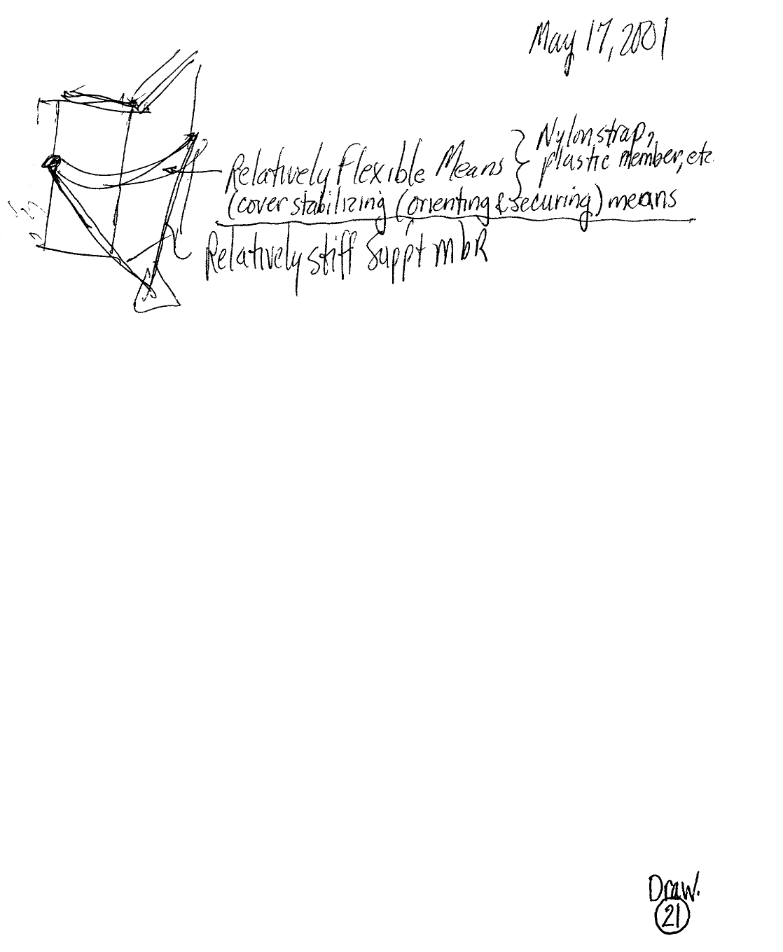

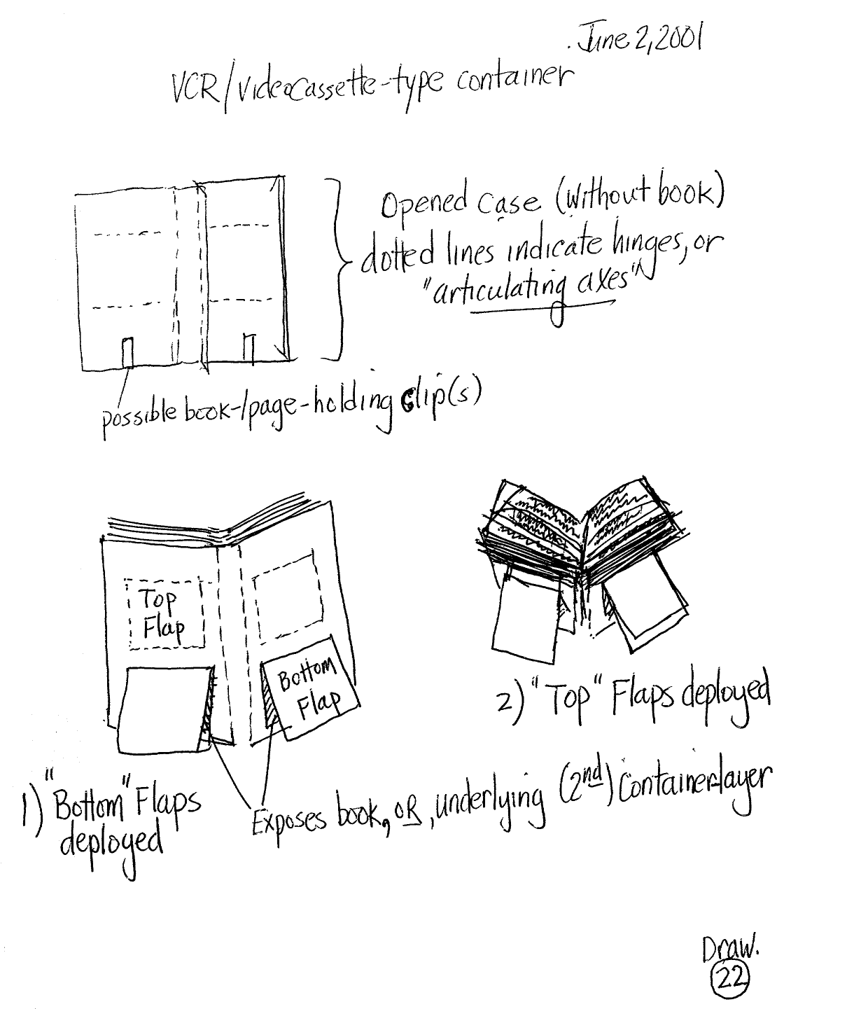

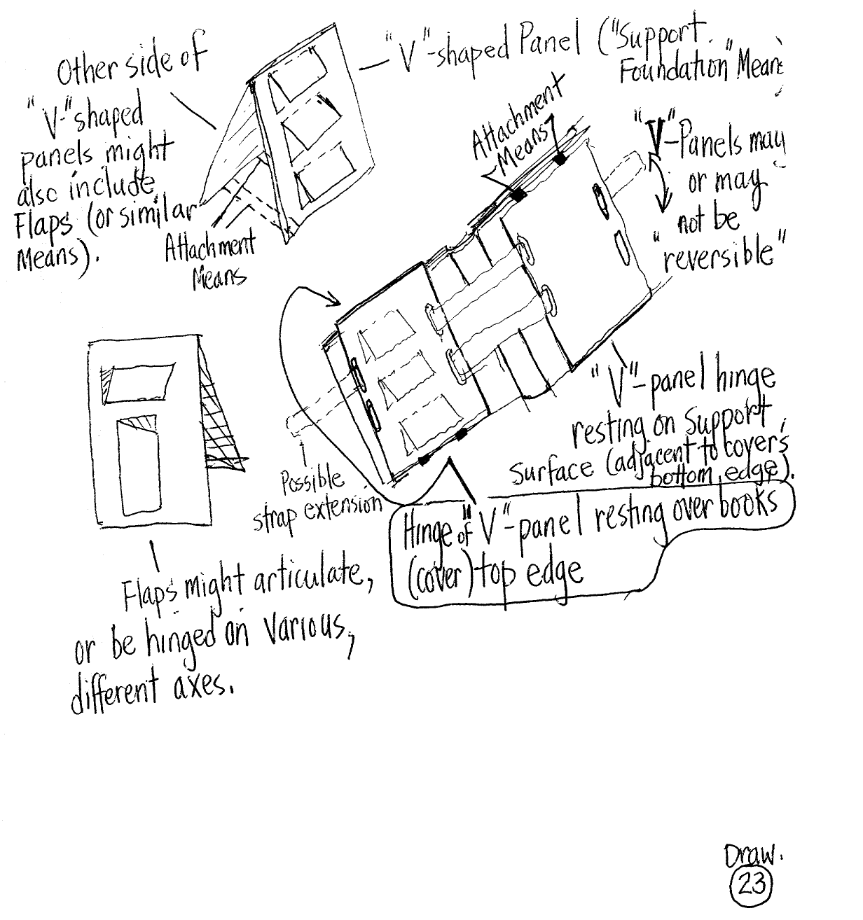

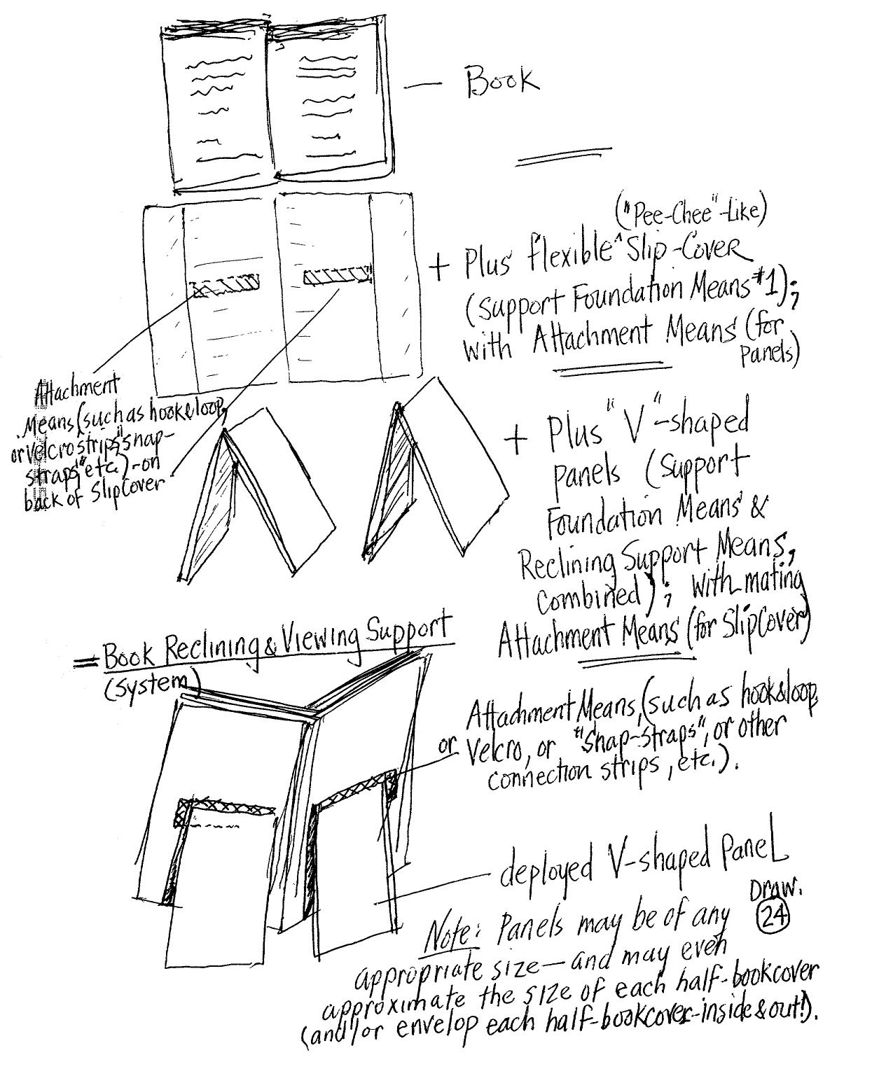

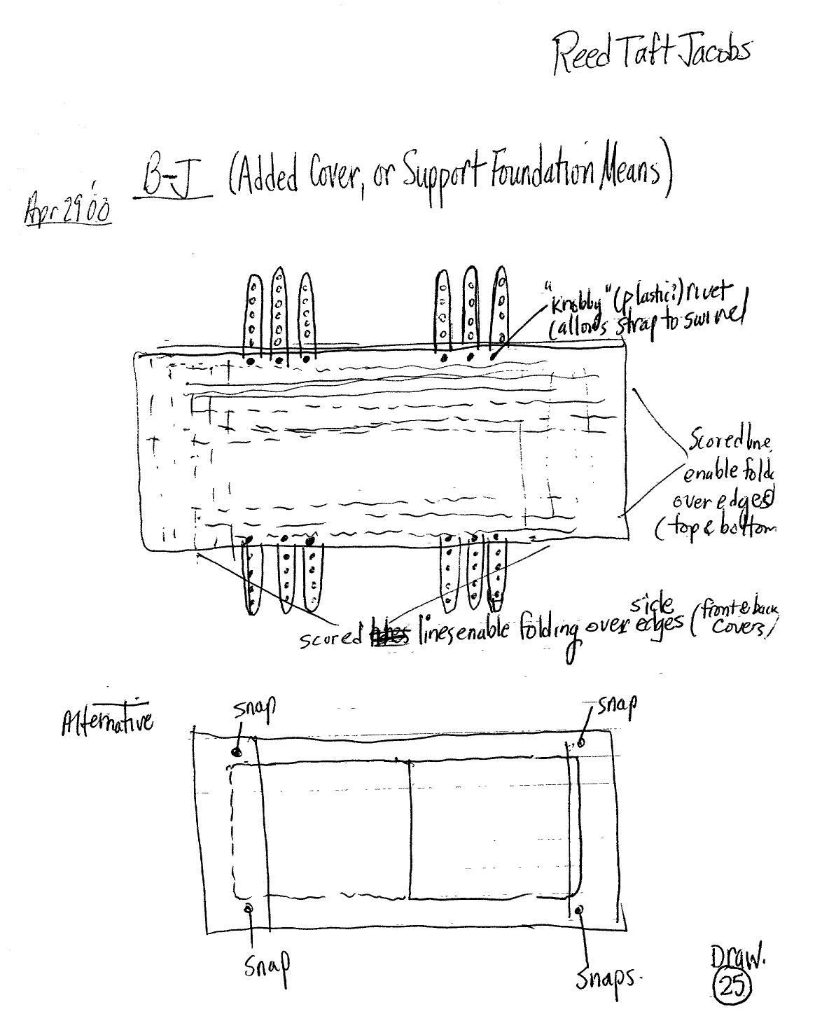

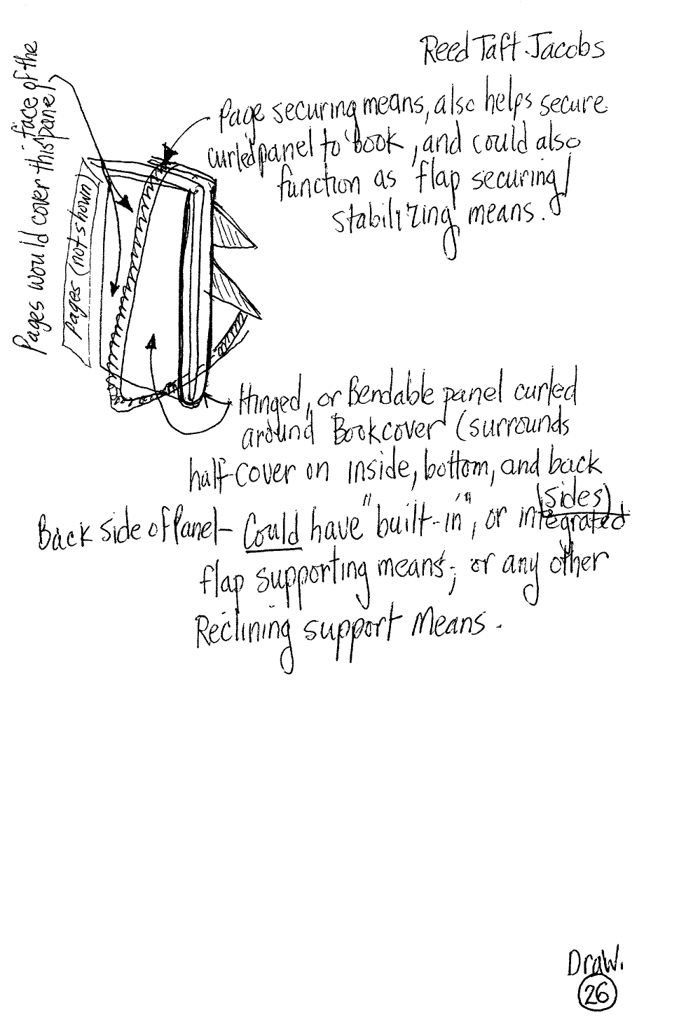

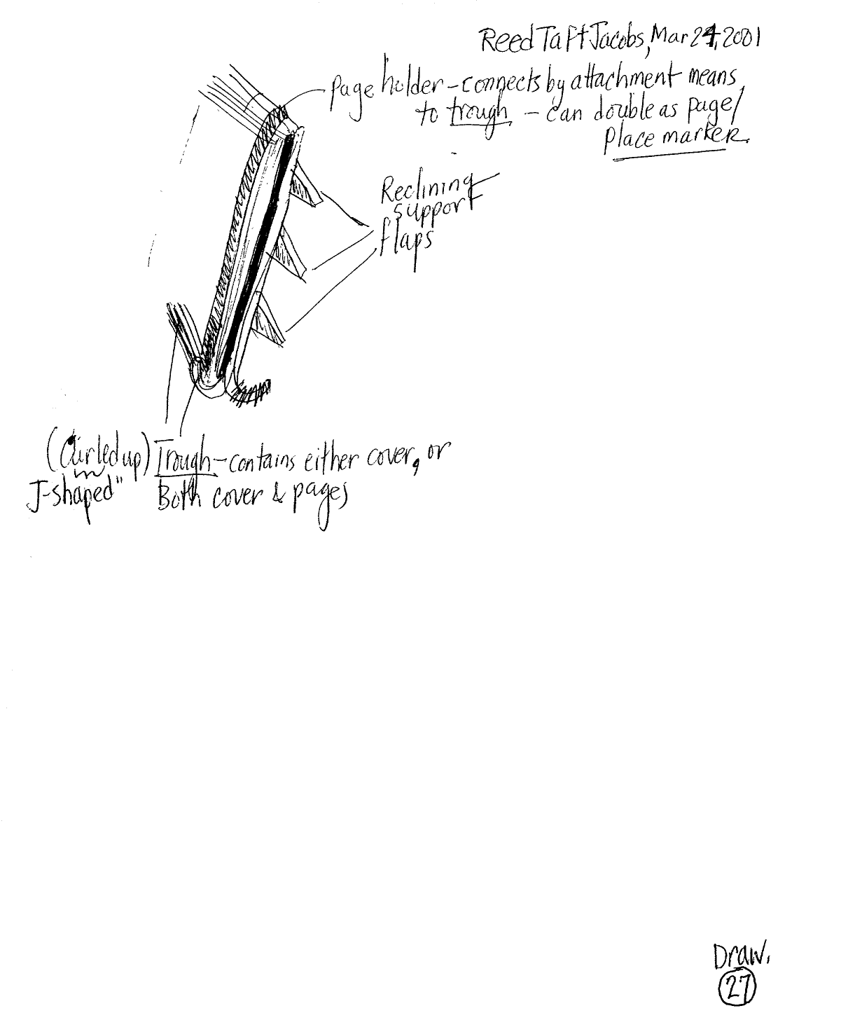

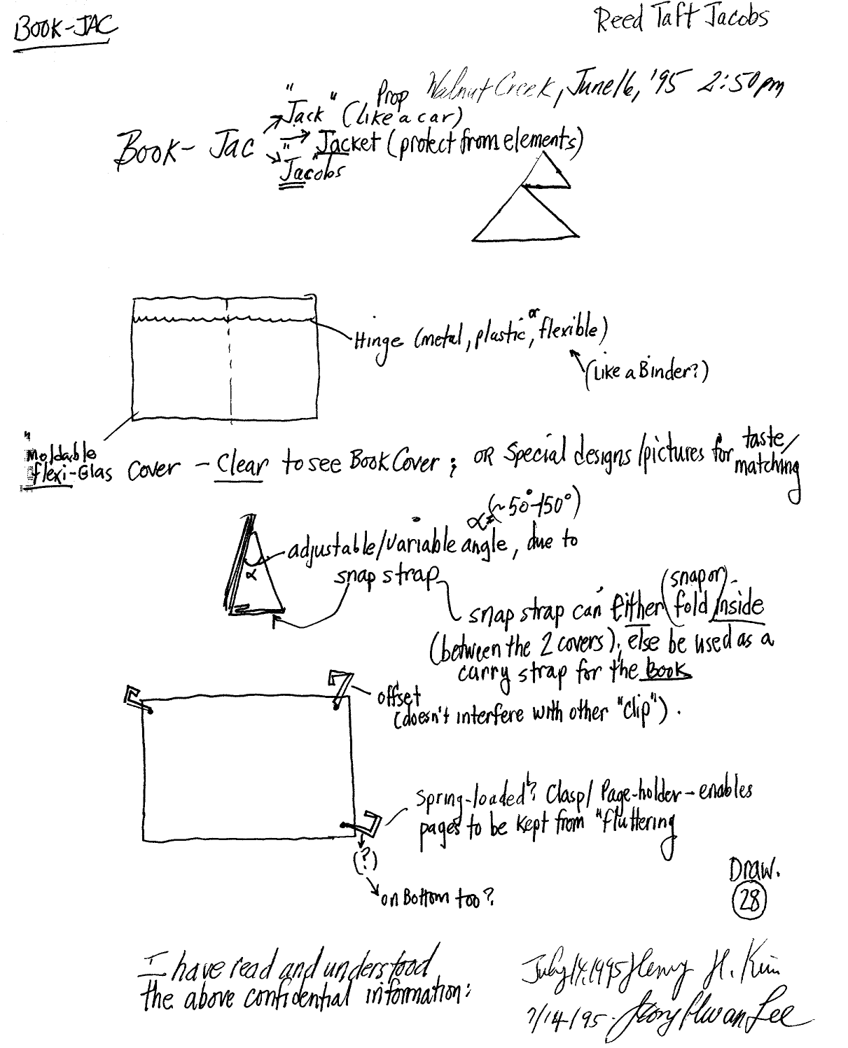

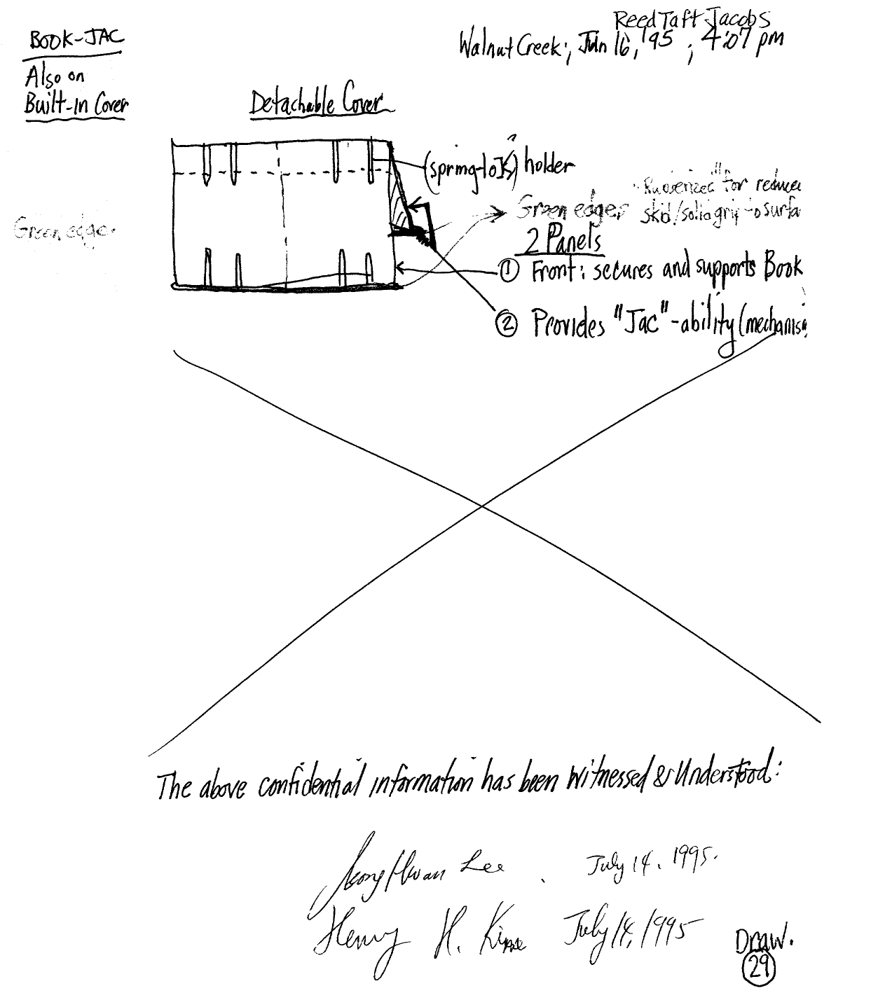

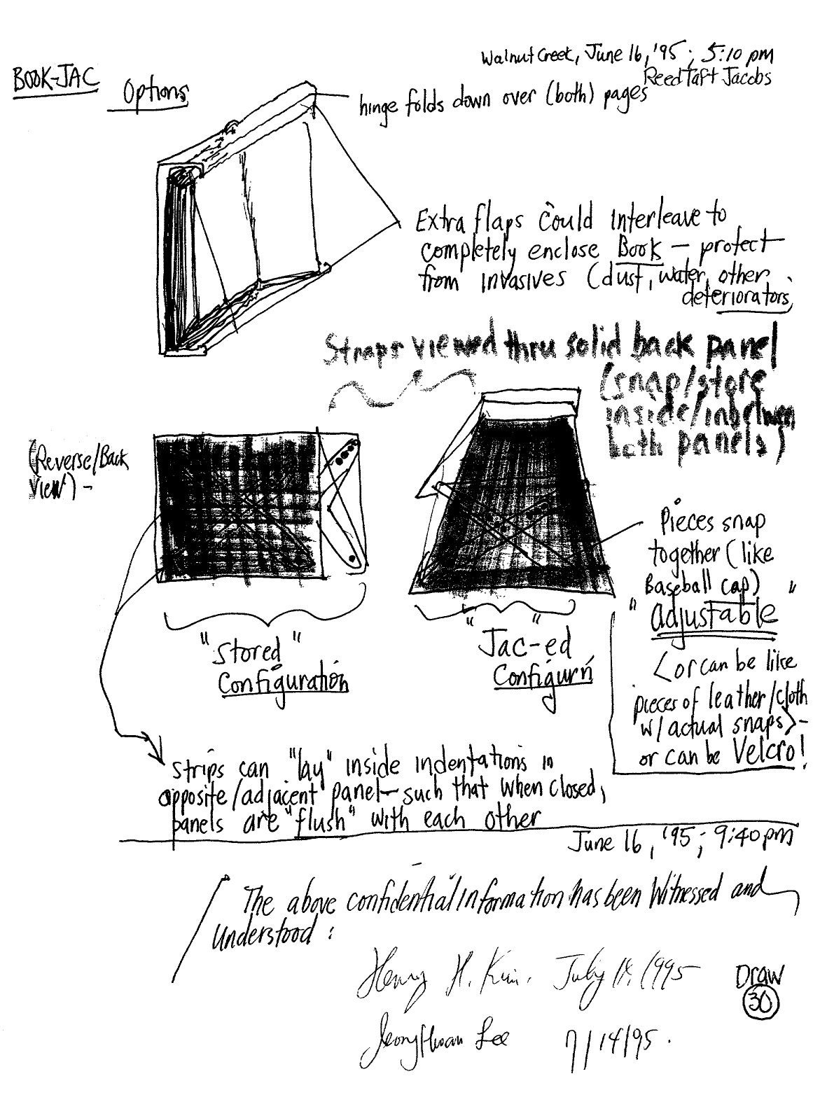

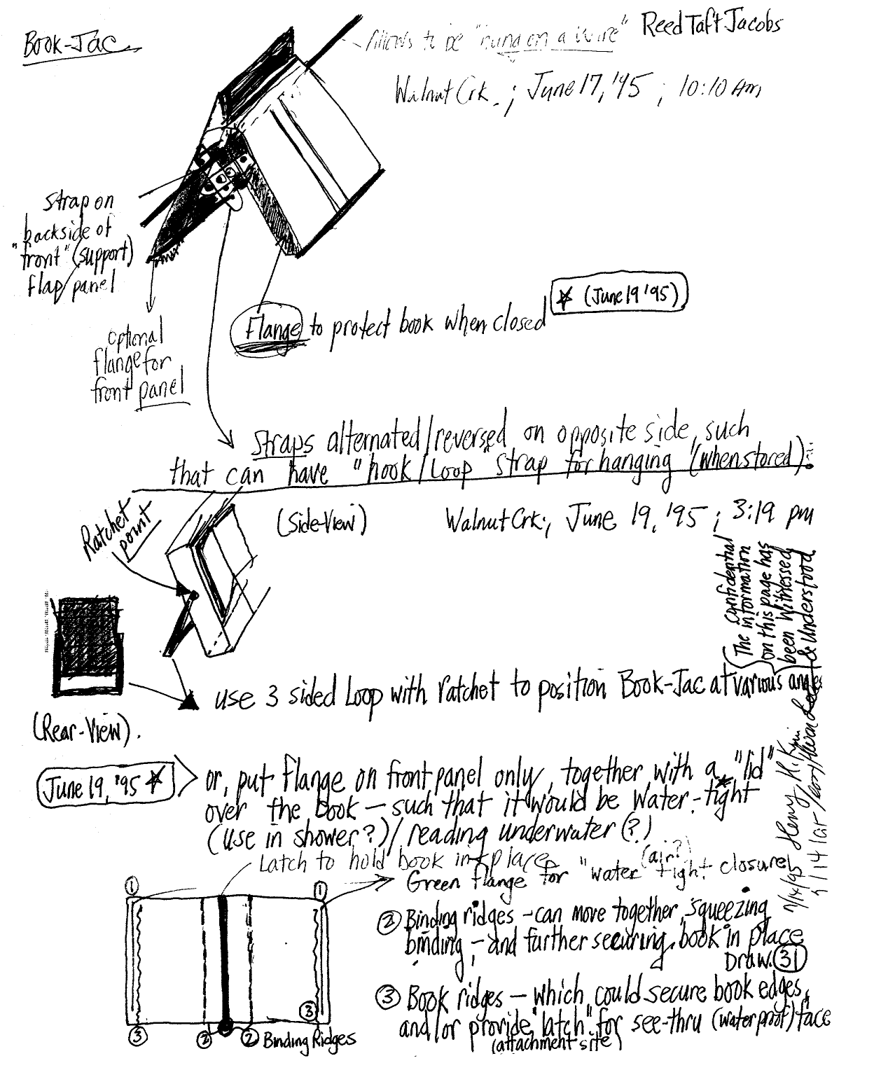

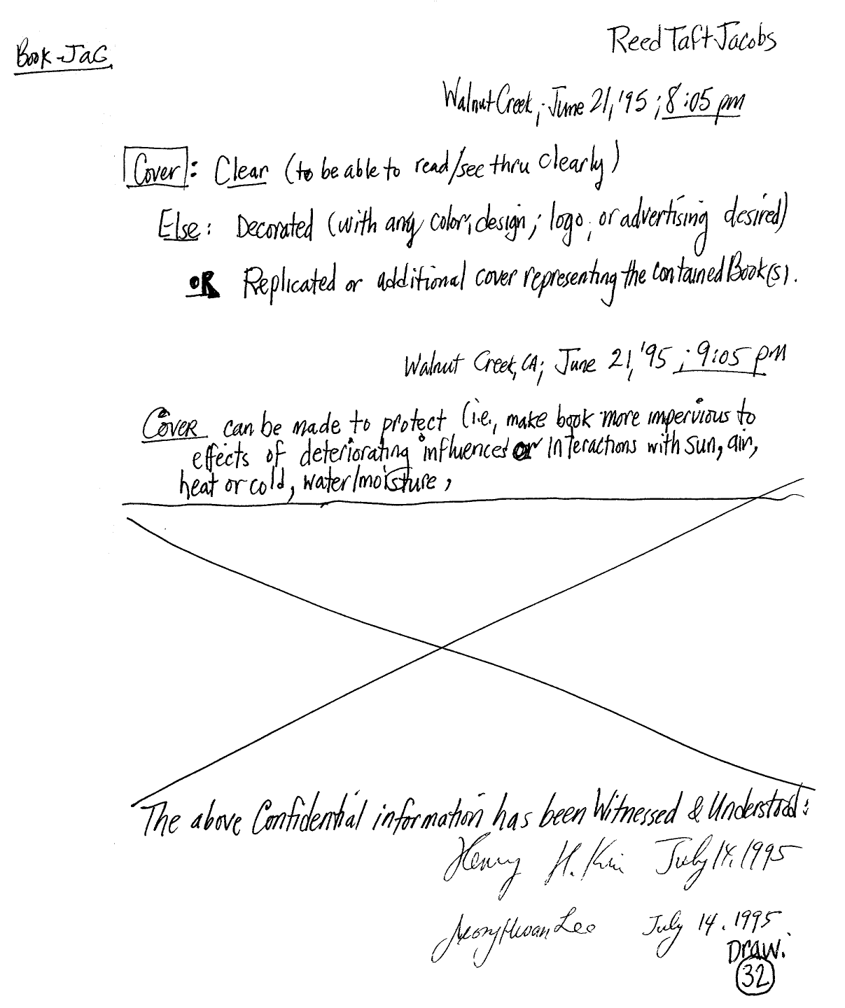

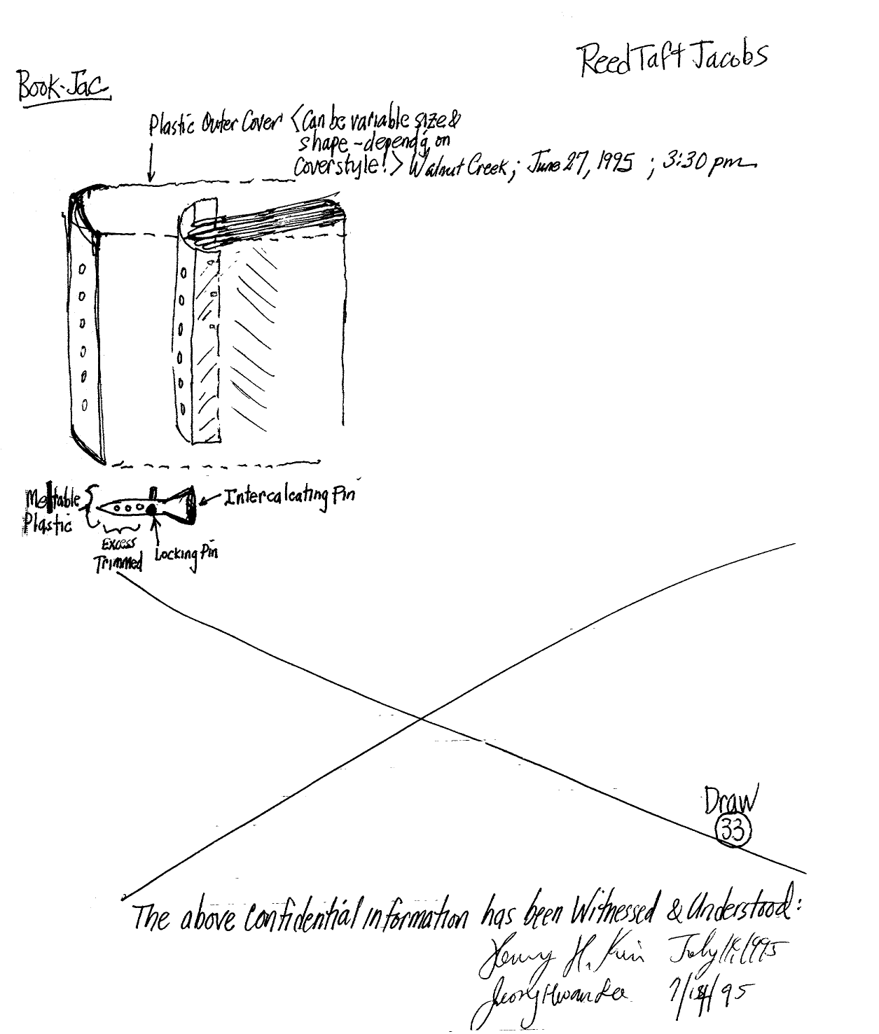

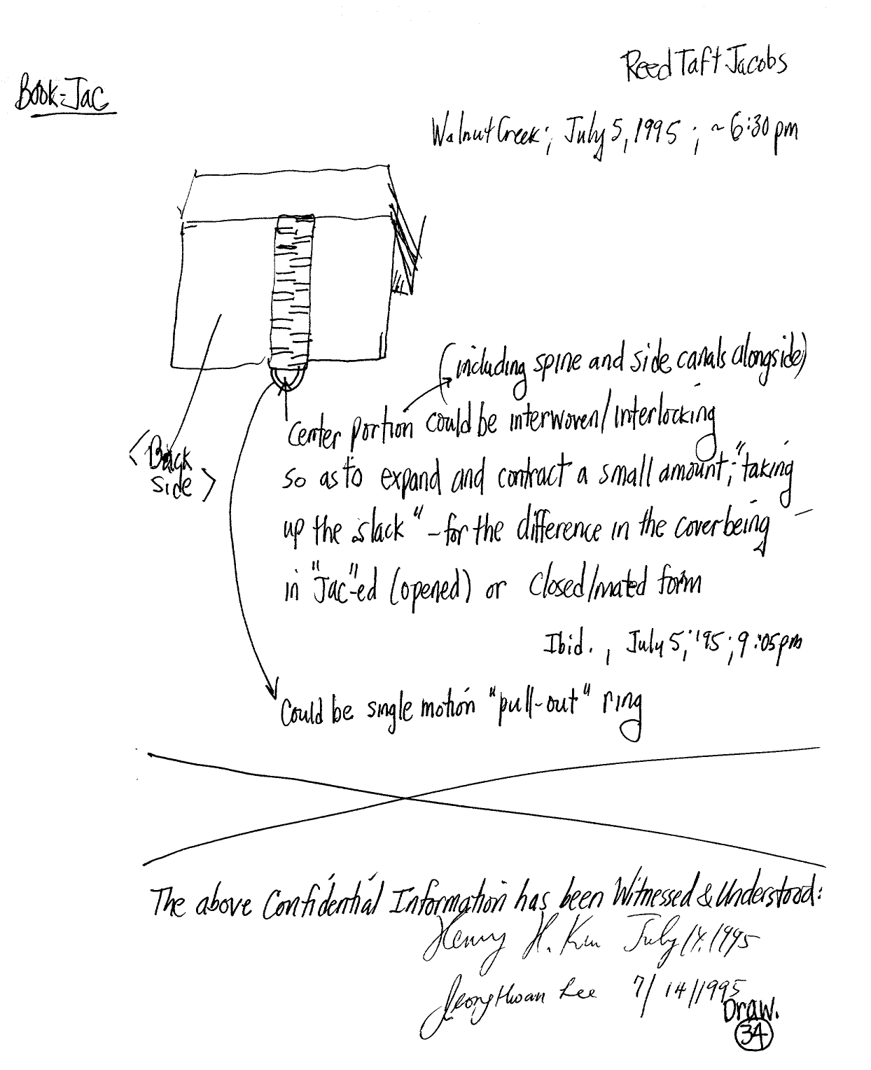

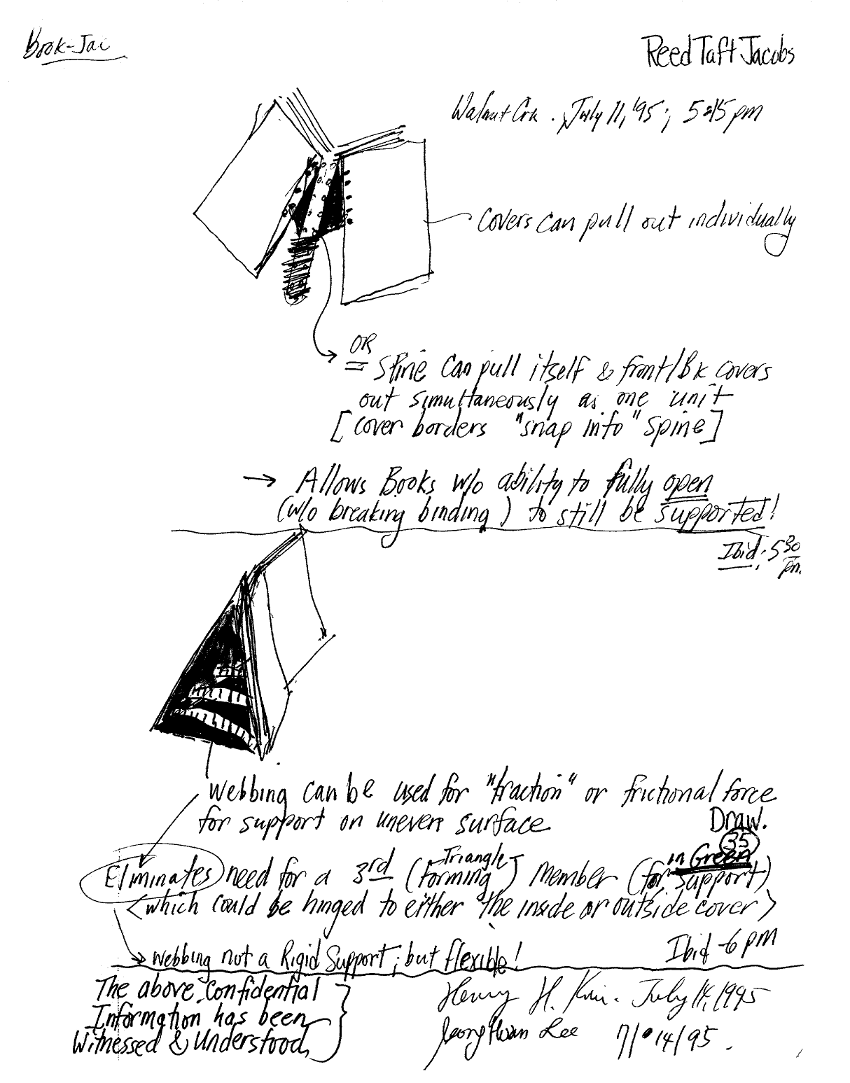

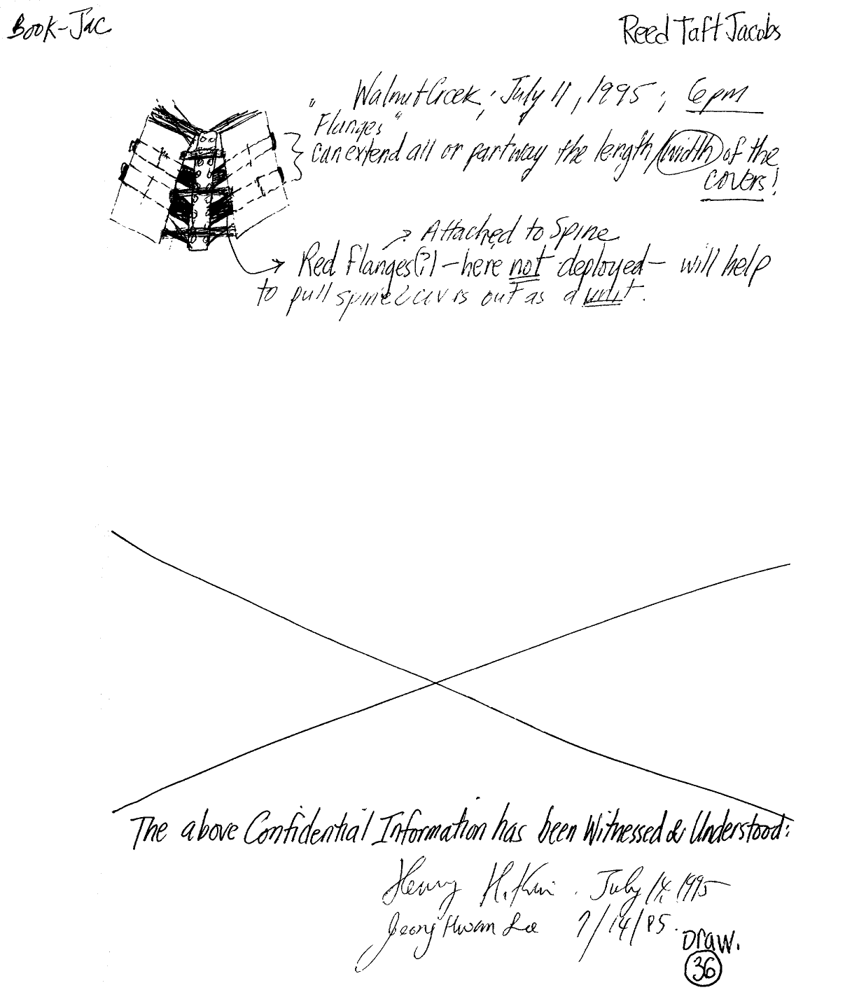

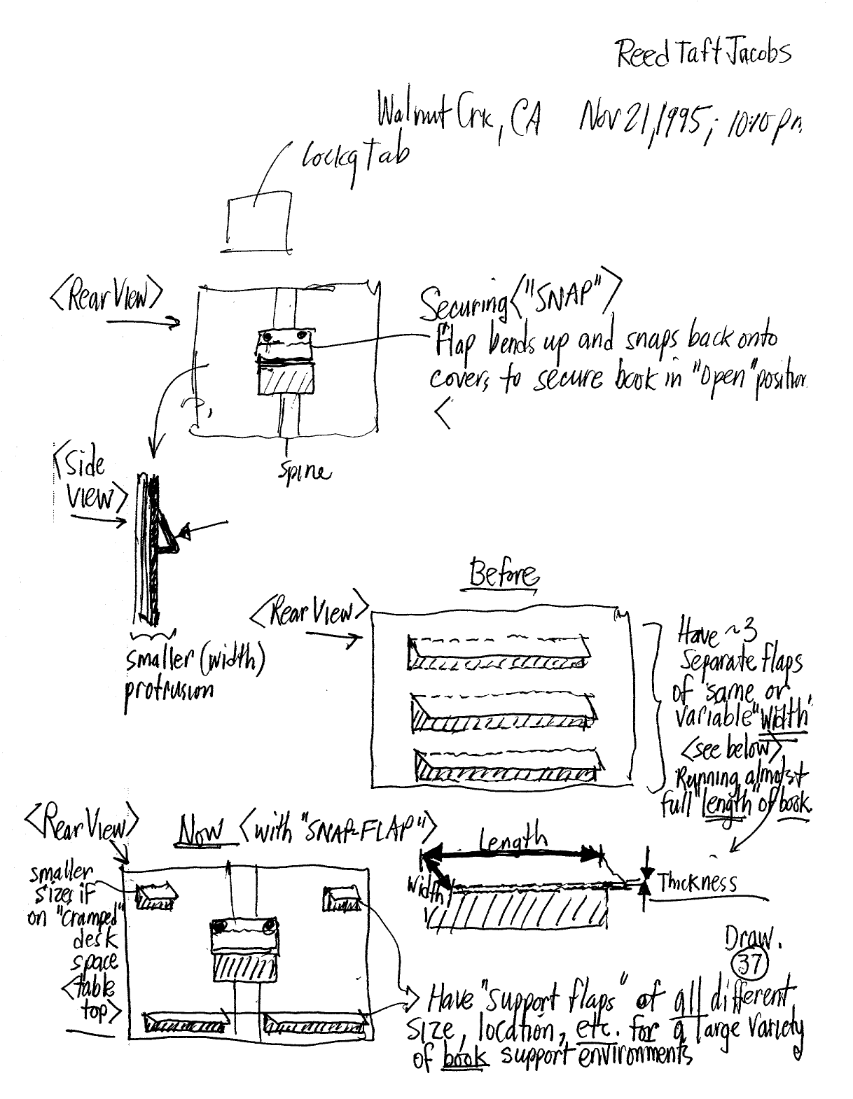

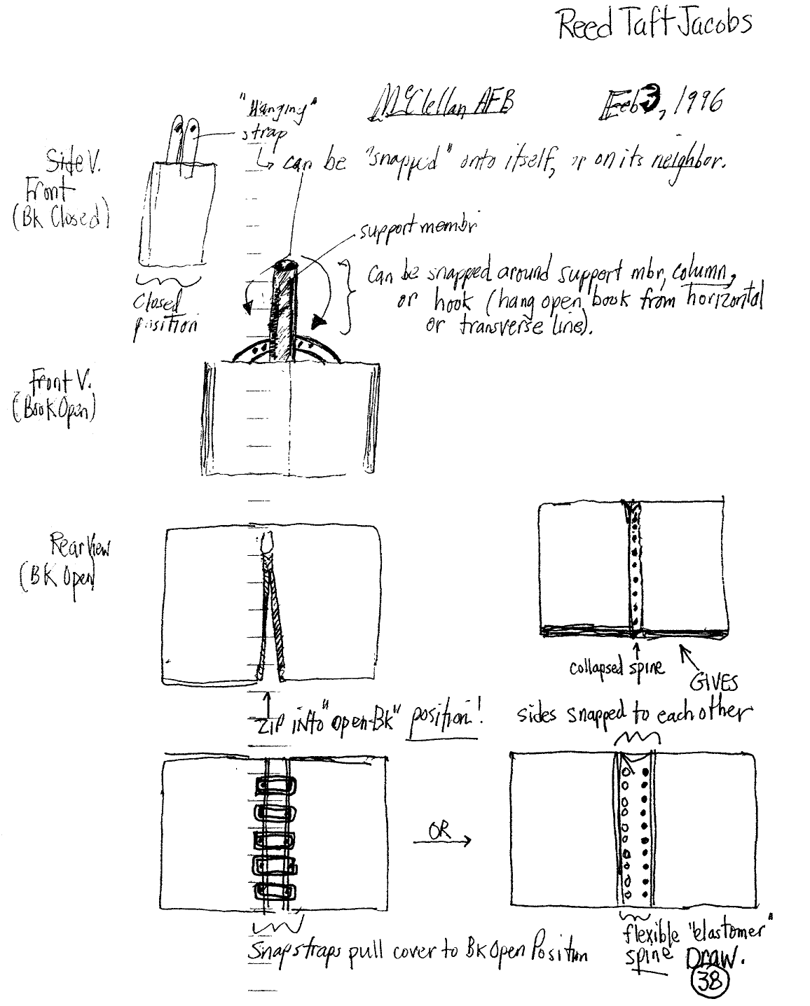

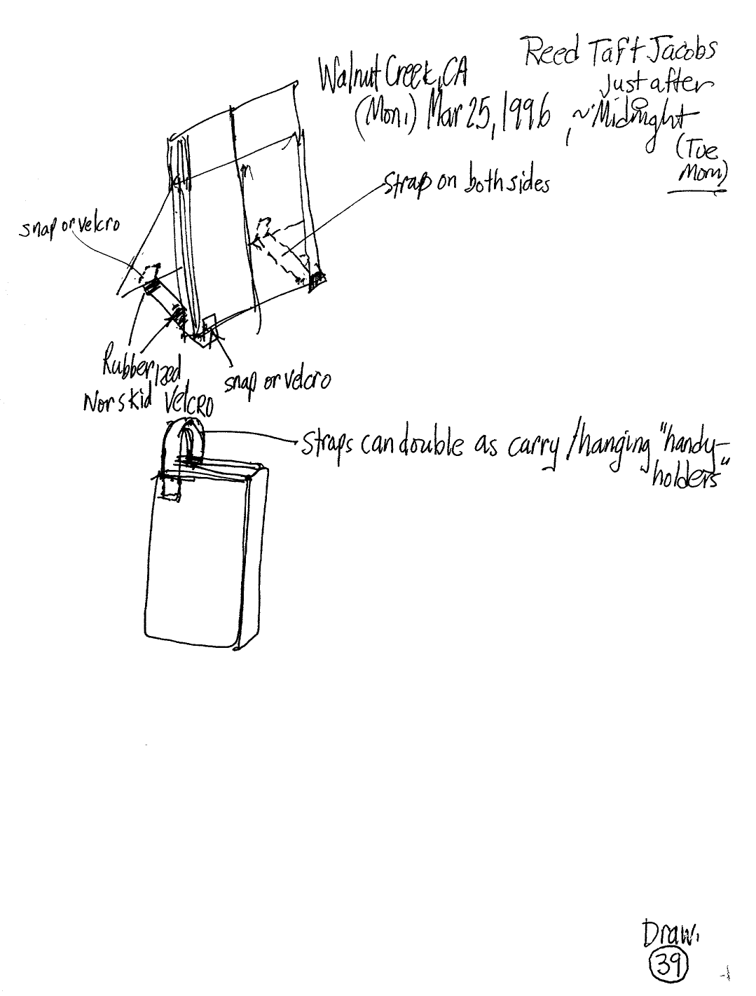

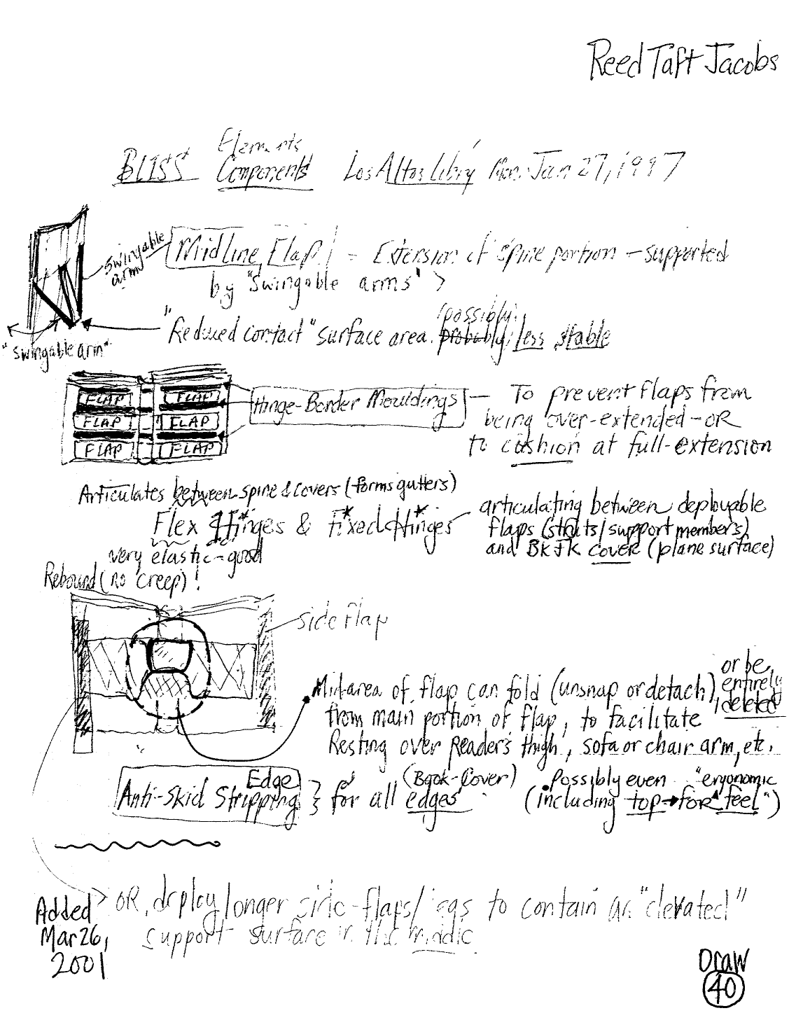

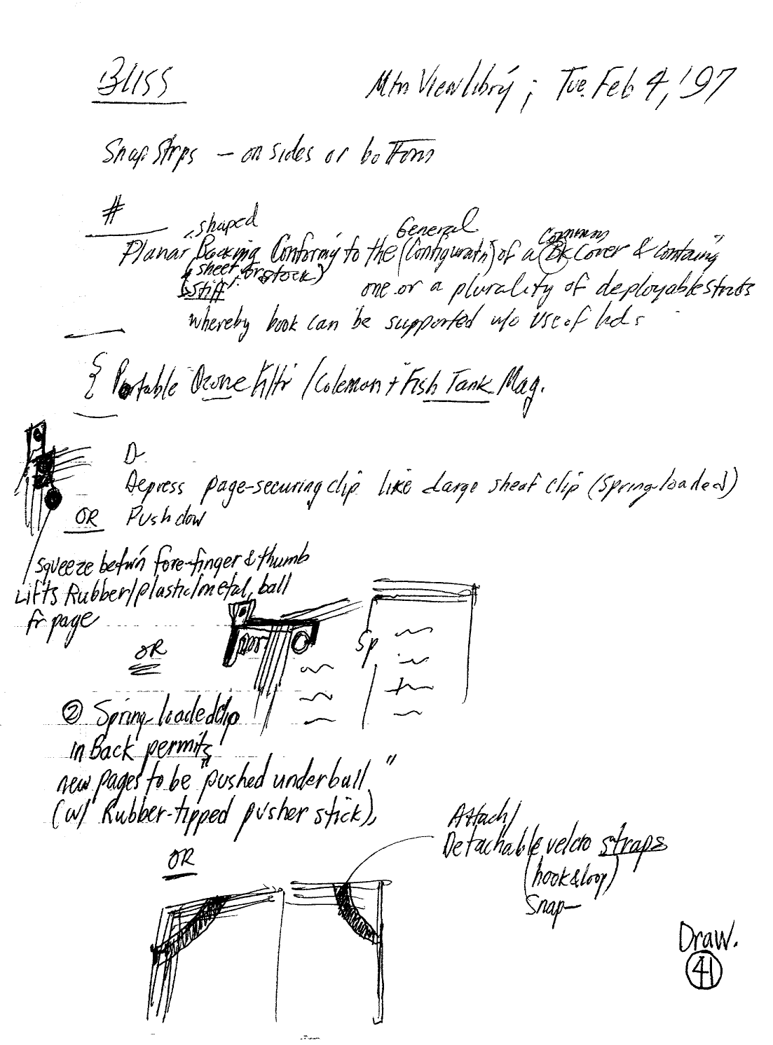

### CROSS-REFERENCE TO RELATED APPLICATION

This application is entitled to the benefit of Provisional Patent Application Serial No. 60/299,503, filed Jun. 20, 2001.

### FEDERALLY SPONSORED RESEARCH

Not applicable.

### SEQUENCE LISTING OR PROGRAM

Not applicable.

### BACKGROUND

1. Field of Invention

Book supports, stands, methods, devices, elements, or structures capable of “hands-free” angular page plane stabilization; and convenient integration to books, bindings, or permanent, or removable bookcovers, or bookcover assemblies; and their configurational or conformational convenience with book usage, transport, and storage.

2. Prior Art

Prior Art has invariably concentrated on solving “symptoms”, or manifestations of a larger “convenience” problem—and thus, have always come up short. As in health and medicine, in order to “get better”, we must first accurately “diagnose” (or define) the deepest roots, and broadest causes and effects of the still-persistent problem; but, unfortunately, prior art has narrowed the scope of this inconvenience situation to mean “hands-free reading” (page-turning excepted); but, in reality, more—much more is required! Besides “hands-free” reading, or viewing, other related “convenience” issues have included the following challenges—addressed to varying levels of minimal, or limited success:

1. Size, and weight (or “bulk”)—and consequent transportability, and cost of the support means (e.g., device, apparatus, structure);

2. Conformance of the support means to both the structural, and usage profiles of the materials supported;

3. Ease, and speed, with which the support means are “set-up”, “deployed” or “engaged”, and subsequently “collapsed” or “disengaged”;

4. Sufficiency of the support function itself—i.e., does it:

a. adequately support the item(s) (is it “stable”)?;

b. preserve the integrity of the bound item(s) supported (avoid, prevent, or guard against damage)?;

c. provide one or more “desirable” reclining angles (wherein “more desirable” has generally been interpreted to mean “causing the plane of the viewed item to be positioned more perpendicularly to the line of sight”); and particularly those angles which correspond to common study profiles (e.g., optimize comfort, focus, concentration, simultaneous note-taking, etc.)?

A more thorough discussion, dissection, and analysis of these “sufficiency” points follows.

In addition to the need to hold or position the book at the proper viewing distance and angle, is the need to hold it open at the appropriate page. And due to the nature of bookbindings, many of them do not so “willingly cooperate”—(another factor often requiring “user support”). These unbalancing forces are substantially relieved with a “lay-flat” (e.g., spiral, etc.) binding—not a “currently viable fix” for a preponderance of presently otherwise-bound materials. Thus, there are associated dynamically shifting (almost ever-changing) “moment and center-of-gravity” (MCG) forces, and correlating “preferable virtual stabilization points” (PVSP's).

These force factors vary not only between binding types (and technologies), but also change with time, as the bindings (glues, folds, stitchings, etc.) are “broken in” (worn), and/or aged. Unfortunately, some prior art solutions require the book's pages to be fully “splayed” in a “generally planar” conformation—which can be “overly stressful” to many bindings, particularly when new.

With the book closed, there is normally no significant moment force around the spine—but this is also quite a disadvantageous configuration for viewing. Once page turning begins, however, it seems as though the characteristics of this moment force could theoretically be different for every different user's “position” (viewed page/scene, stabilization factors, and environmental situation). The center-of-gravity similarly changes (primarily in the horizontal component thereof), as pages are turned. Components of these forces also change with changes in the angle of the book with respect to its “stabilizing” (resting) surface(s); as well as with external forces from “outside” (e.g., environmental conditions—wind, etc.). Many prior art solutions have proposed a tripod-like support structure of a single strut which is splayed from the spinal area—but whose configuration appears instability prone due to anticipated MCG forces.

Also, a strut support is increasingly rotation-prone for more thinly-bound (spined) books.

Desired angle of the book is related to the previously-noted variable reading position (“support sufficiency”) problem—but again, is more complex than at first appearance. This is because it relates to the “comfort” of each individual user—and thus, to each person's physiological, and psychological variables connected therewith.

With a book “flat on its back” (i.e., lying horizontally on a table, with no angular support function)—one generally “compensates”, by “craning” (bending) their neck and back in order to get a “comfortable” (e.g. generally more perpendicular to their line-of-sight) planar view of the page(s). Also, ambient lighting (and glare factor) is often a noticeable angle variable. Finally, due to varying visual acuity, posture, musculature, neural and fatigue sensitivity characteristics, and individual “preferences”—an adjustable angle capability has been presumed optimal. Angular alterations are also appreciated for other desirable reading positions, including standing, lying down, or “reclining” (in a chair, or bed).

For the sitting position of reading, or study, however, there is a more subtle issue of “perceptual comfort” (explained through psycho-physiological experiments, but absent from prior art's design considerations). Though it's often physically helpful, or less stressful, to have a certain degree of angular displacement (from a desk, for example); too much inclination (displacement) is definitely counter-productive! This, because of the resulting potential increase in the “distraction component” of the visual scene impinging on the outer area of the retina—whose rod-receptor cells are especially sensitive to movement, and visual (or illumination) changes on the “periphery” of the field-of-view; whereas, it can “accommodate” to a static desk, or study “scene”. Therefore, too much inclination leads to greater probability of distraction from the study material at hand—which should be focused on the retinal fovea—and perceptual concentration is compromised! This is a major drawback to the designs of Barrett (Reissue No. 21,371), and Gerald (U.S. Pat. Nos. 3,747,889 and 3,339,875), Bloom (U.S. Pat. No. 3,981,522), and Baum (U.S. Pat. No. 472,470), as well as many easel-type designs!

Another related drawback to these designs is that they cause a “dis-joining” or separation in the fields of view between the reading or study scene, or plane, and that of the writing table or plane—which activity is also often conducted in conjunction therewith; and which otherwise (at optimal angular book displacement) could relatively largely coincide. Thus by solving one convenience factor, they unwittingly create a perceptually distractive awkwardness (i.e., “jumping between fields-of-view”); as well as a physical awkwardness, particularly if one is used to writing in the book's margins (as well as on paper). Thus, improved angular stabilization designs should optimize both perceptual, as well as physical comfort.

Thus, “focused reclining” options (on behalf of both book, and reader) have inherently enhanced comfort potential! (note: the term “reclining” is used herein to describe a book's angular displacement from “normal sitting position”—in similar attitude as in a “reclining chair”; although “inclining angle” (from the horizontal support plane) might be deemed to be a more inherently “technically accurate” description, since it is primarily the plane from which the book is supported, and/or “tilted from”). But, on the other hand, when describing factors of “convenience,” we are speaking in reference to the human user, who generally views bound materials from a generally vertically-oriented sitting position; and therefore, in a perceptual sense, “reclining angle” is also accurate.

Indeed, “psychological perceptions” are sometimes a more important “reality” affecting personal choices, or decisions—and despite the reclining, or inclining options afforded by the prior art—the sense of “true total system convenience” has also been incomplete—as is this invention's aim to remedy! In fact, true total system convenience is concerned with both function and structure (i.e., “form, and fit”), including the interfacing factors, methods, and elements required from the book, and its user, in order to effect preferred, or optimized reclining angular stabilization—together with other desirable ancillary functions of environmental (and structural) protection, page securing, and convenient transport, and storage). Providing simply-integrated, smoothly-interfaced thoroughly-convenient, and cost-effective support systems is what's needed.

Substantially freeing the reader from book and page-stabilization, and handling requirements has been the goal of numerous prior design attempts. Some generalized categorizations of solutions include:

1. “Stay open” cookbooks—requiring 3-ring binders, or spiral “lay-flat” bindings; or requiring the pages or recipes to be bound in “landscape” orientation;

2. Support, or display devices (apparatuses) which are overly complex, and/or extremely bulky, awkward, or heavy; or lacking the capability for streamlined integration into the same constructional conformation as the book itself;

3. Devices which are tedious to set up, costly to manufacture, or somewhat unstable; and

4. Devices having a very narrow application—for example:

The Crawford Display Binder (U.S. Pat. No. 4,355,821), wherein the cover bends out, away from the pages. This provides only one viewing angle, and of course, is not compatible with present (single-layered, or single-surface) bookcovers—since they are permanently bound to the pages. Also, many book spines can often be easily, and permanently damaged by being so “widely opened” (in the view binder's “180 degree planar configuration”). Finally, by bending back the “only” cover, it exposes the pages to increased stress, and damage risk; and provides less than optimal stability.

These prior solutions have not been widely applicable, or acceptable to books in general, for failure to appropriately tailor them for broader application(s); or by failing to effectively, or cohesively, or more cleverly provide one or more of the following desirable characteristics, and/or target benefits:

implementation speed, or ease of use of support functions;

adjustable, or adaptable support means to different types of reading materials, and various user environments or situations;

integrated support means, which either in whole, or in part, can attach to, or interface with the book's cover; and are largely compatible, amenable, or conducive to the “normal” orientations of books—whether open, or shut—while being viewed (utilized), carried (transported) or shelved (stored).

aesthetic, artistic, and/or emotional appeal.

Objects and Advantages

The optimal solution(s) will thus be found through an “integration and simplification” approach; wherein tailored total system convenience (incorporation of the above target benefits), and other desirable features;—particularly optimized, together with possible adjustable angle stabilization,—are appropriately integrated with books, bindings, bookcovers, and/or cover assemblies into a cohesive whole!

Therefore, instead of making separate portfolios and binders, easels, stands, lecterns, etc., on which to “recline” the book—why not rest it on its own structure—or smoothly interfaced elements, which conform approximately thereto? This departure from the prior art can be likened to a similar innovative leap taken with luggage carriers. While carrier manufacturers busied themselves in constructing better wheels, or sturdier frames; and luggage designers focused on sleeker fashions, and innovative materials—someone (with an integrated, or total system convenience approach) finally concluded to put the two industries, and technologies together! Thus, we now rarely see larger high-quality modern airport luggage without the wheels (and pulling means) attached.

### SUMMARY

A new “book and bookcover paradigm” is delineated herein—which integrates a useful function—in similar manner as with wheeled luggage (or even wheeled shoes—a recently added feature to kid's casuals), wherein a reclining support means (function) is combined or attached directly thereto. Or in the case of retrofitting or accommodating this solution to existing books and covers;—made available through removable, or slipcovers; or, by adding (interfacing) support structures or functions which are “easily” (conveniently) attached, configured, manipulated, transported, and stored with the book.

An excusable exception to this “structural conformational alignment” goal might be made for potential support objects which some readers might naturally use and/or carry as a matter of course, activity, or habit; including pillows, water bottles, toys, tools, sports equipment, containers, hats, or other articles of separate useful function—many of which might be inflatable, or expandable to accommodate a book supporting function.

This Invention contemplates methods for propping or supporting a book* (please note the broadened definition given in bold typeface below), primarily on a generally horizontal surface. Possible surfaces might include “furniture” (desks, tables, beds, benches, couches), a countertop, shelf, work station, one's lap, or the ground. Vertical, combined, or other display surfaces, and/or methods (however) are also contemplated. One anticipated advantage of the support feature is the ability for the reader to read or study the book at a more comfortable viewing angle. Another advantage foreseen in many appropriate applications, is the reduced requirement placed upon the reader, or viewer to continuously handle, hold, or support the book. Persons who could benefit significantly from these added features include those who wish to “view” pages (leaves) while also: Eating; Studying (writing, calculating, designing, or creating); Holding pets, objects, or small children; Cooking; Performing chemical, or scientific (lab) experiments, or procedures; Doing repairs, “fixing”, or assembly operations; Constructing crafts, or creating handiwork (hobbies); Experiencing a disabled (less abled), weak, old, sick, or illness condition(s); Practicing art, music, or dance skills; Teaching, or public speaking; Typing, word-processing, computing, etc.

(* Note: “Books” per se, comprise only a subset of this Invention's applications or uses. Although books are envisioned as the primary application, embodiments of this Invention may be utilized to support other bound (and even unbound) materials, including: printed pages; photographs; artwork; drawings; music; assembly, maintenance, repair, or operating instructions; and word processing, typing, or data entry materials, etc.—which might be contained, or secured by albums, magazines, workbooks, notebooks, clipboards, dayplanners, manuals, writing tables or folders, portfolios, and binders, etc.; and protective covers for such . . . in addition to books).

In other words, all readers or viewers who may wish to occupy their hands with other activities, (or not at all—including those who may be restricted in their hand usage (handling) abilities, options, or desires).

Although the reading or viewing public may yet be unaware of the potential advantages of “freeing up” their hands; we might liken the situation to the telephone, prior to “hands free” headsets, and speakerphones. And though these communication innovations are still “catching on”, they conceivably may soon command the entire market for certain situations, namely with vehicular cell phones—due to the difficulties, distractions, and dangers inherent in “dialing and driving”.

In addition to including/improving upon these features, possible solution embodiments of the present Invention might inherently include variable book reclining angles, to enable comfortable viewing from various “viewer positions”—including lying down (on one's side, back or stomach); or while standing, sitting, or reclining. These variable “book reclining angles” increase the opportunity for comfortable viewing (individual “angle tailoring” to the users' head, and/or body position(s)), as well as helping to avoid glare; and offering a possible reduction in neck, and/or arm, hand, or finger strain.

Invention Overview:

The present Invention (solution) comprises several unique, and unobvious support embodiments, which more cleverly provide one or more of the above reclining support advantages (with adequate sufficiency), integrated together with total system convenience (i.e., the aforementioned “target benefits”).

They are substantially based upon effective book reclining support means innovations. These reclining support means or methods may be further augmented, or enhanced by: a cover stabilizing (orienting and securing) means; a page securing means—to further reduce book “handling requirements”; an environmental protection means; and a book carrying (transporting) and/or storage alternative means. An alternative display or support means is also envisioned. Such enhancements are automatically implied as “probable, potential, or possible inclusions” to each of the various ramifications of each different embodiment (and therefore may, or may not be included in drawings, illustrations, or descriptions).

### Book Reclining Support Means

These appealingly simple, and uniquely effective Book Reclining Support Means, are deployed from, or integrated into, or separably, yet smoothly interfaced with the book's cover itself (including permanent covers, or removable covers). The support system as a whole, as well as its sub-elements (and/or components which comprise, and/or connect, or attach to them), could be permanent, or removable, (i.e., permanently, semi-permanently, or temporarily mounted to the bookcover, depending on the particular embodiment, and/or ramification); and may include one or more of the following:

Flaps, or “Windows”;

Inflatable/expandable Flaps, Pockets, Sections, Compartments, or Protrusions;

Forms or Objects (balls, blocks, bags, figures, etc.)—including those which are filled, or are inflatable/expandable;

Members, Trusses, Frames, Containers, or Panels.

Complementary sub-components (“Attachment Means”, and “Support Foundation Means”—see below), to these book reclining support means), are all also deemed important, and/or useful, though some may, or may not be absolutely necessary, or critically required. They are also implied as “probable, potential, or possible inclusions” to each of the various ramifications of each different embodiment (and may or may not be included in drawings, illustrations, or descriptions).

### DRAWINGS

This patent covers a vast array of reclining support means—as they might be incorporated or combined into a permanent or removable bookcover. Only a few of the numerous possibilities are illustrated here; (appropriate formal drawings, as required, to be submitted upon application allowance).

Draw. (Drawing) 1 shows a “reclined” book, resting on “detachable” flaps, or “windows”.

Draw. 2 shows a notched, or ratchet-like means whereby flaps (or other support means) may be raised or lowered in elevation.

Draw. 3 shows a novelly-hinged outer cover, which may be manipulated (folded) to provide an optimized book resting position. This angle might be adjustable with different folding-angles, or even with “elevating spacers” which could slip over the edges of the wings.

Draw. 4 shows interleaved (or nested) flaps, in which smaller area flaps could be “incorporated” into the structure of larger flaps or “windows”—which may be hinged, or articulated at any angle.

Draw. 5 shows one method for engaging, or deploying flaps, or “windows”.

Draw. 6 shows another way that flaps might interact with each other.

Draw. 7 shows an inflatable support means permanently, or removably built, or integrated into a bookcover.

Draw. 8 shows a semi-circular “cover stabilizing means” which provides enhanced spinal support.

Draw. 9 shows different types of possible inflatable, or stuffed support means.

Draw. 10 shows an expandable compartment, and articulating member or strut support means.

Draw. 11 shows a clip-like attachment means which might house, or provide an articulating joint for members or struts; together with a joining sleeve, and/or surface gripping means for such.

Draw. 12 shows special articulating flaps which might be used for purposes other than reclining support; it also shows a potential book-supporting function added to case similar to those used for video-cassettes.

Draw. 13 shows two forms of support means, which might be “separable”, yet easily-integrated into a cover assembly.

Draw. 14 shows two means by which separable figures, or toys may contribute adjustable reclining support.

Draw. 15 shows an example of the limitless possibilities in which various support means might combine.

Draw. 16 shows how an otherwise detachable articulating ring, or handle could also conform to the “closed book orientation”.

Draw. 17 shows how telescoping rods, and/or struts might be used in combination.

Draw. 18 shows a crossed-rod configurational method (again, possibly telescoping), for generating member support.

Draw. 19 shows a flexible curtain with adjustable support characteristics.

Draw. 20 shows another type, and configuration of flexible support means.

Draw. 21 shows a stabilizing (spinal support) means, in conjunction with the book reclining support means.

Draw. 22 shows how flap reclining support, and page-holding features might be added to a videocassette-type bookcover or book holder.

Draw. 23 shows how support foundation panels, together with reclining support flaps might be added to an existing bookcover.

Draw. 24 shows how a removable or slipcover together with detachable V-shaped flaps could be added to an existing bookcover.

Draw. 25 shows how a single scored sheet of material with appropriate attachment means could be added to an existing bookcover, to give it more strength Draw. 26 shows how page securing means could function dually as a flap restraining, or tethering means.

Draw. 27 shows how a support foundation (or added panel) means could incorporate more than one type of page restraining means—namely a page-holder strap, or band, and a “J-shaped” trough.

Draw. 28 shows alternate forms of flap-tethering, and page restraining means.

Draw. 29 shows alternate forms of book holding, and surface gripping means incorporated into a detachable cover.

Draw. 30 shows alternate forms of book/page holding, and flap-tethering means.

Draw. 31 shows environmental protection means, reclining support means, and book-holding means embodiments.

Draw. 32 shows another page from the workbook—indicating how this invention has been in a continual process of documented development since 1995.

Draw. 33 shows how a reclining support means cover might be attached to a interfacing plate located about a book's spine.

Draw. 34 shows how a single sheet or flap, functioning as a reclining support means, might have a flexible portion built into the spinal area—in order to compensate and relieve the misalignment, and/or binding stress anticipated upon deployment.

Draw. 35 shows how an added support cover could be comprised from two cover panels, and a spinal strut; also the dual-functionality of straps as flap-restraining, and surface-gripping means.

Draw. 36 shows how a similar reclining support means embodiment shown in Draw. 35 could include other “flanges” or attachment means—to enable functioning as a single support system.

Draw. 37 shows different flap-functionalities; as a cover-stabilizing means, as well as a reclining support means.

Draw. 38 shows a dual functionality for straps—as a book-hanging (suspension) means; and also means for adjusting the cover area around the spine.

Draw. 39 shows again the dual functionality of straps indicated in Draw. 38.—only in this case, for suspension in a storage, or transport configuration.

Draw. 40 shows a combination support means comprised of a spinal strut, together with articulating “swing-able” side arms; also shown are flap-hinge cushioning moldings; and a specially curved flap with dual-functionality (besides as a reclining support means), for sitting over one's knee/thigh, or the arm of a chair, couch, etc.

Draw. 41 shows different page-securing means embodiments.

### DETAILED DESCRIPTION

Preferred Embodiment

Flaps or “Windows”:

These Reclining Support Means are hinged, or otherwise articulated to the bookcover. They could be “built-in” (integrated into the bookcover's surface), or standalone “add-ons” (of any configuration), similar to any hinged, or articulated member(s) used to support a picture frame. A likely embodiment would incorporate them into a “secondary” (either permanent, or applied) outer surface (i.e., into a permanent, or removable second cover)—mostly matching or conforming to that of the “conventional”, (original, or normal) bookcover. The Flap(s) or “Window(s)” could then be deployed from this “second cover” (outer surface layer), much like a hatchback is deployed open, away from the surface of an automobile; or as a horizontally hinged window might be opened at some angle with respect to a building wall, or surface . . .

There could be one or more deployable Flaps, or “Windows” on each half-bookcover; and they could be arranged in groups of equal, or differing sizes, or heights (“tiers”). When the “windows” are flung open (deployed) on any tier, this then allows the (figurative) “building” (book) to be reclined (i.e., “rest” on the opened “window(s)”) at varying angles from the horizontal. A likely embodiment would probably include one “Window” (Flap) on each tier (at the same level on each half-bookcover); and at least two or more tiers, of equal, or unequal proportion, size, or height. Flaps could be designed to open from either top, or bottom (or the sides).

Each Flap might include “moldings” (protruding ridges), or wedges, or “stops”—next to, or running alongside the articulating (hinged) axis, to “block” the flap (brace the Flap opening) at its preferred, and/or widest opening angle(s). These, or other permanent, or adjustable “angle stops” might be added to the flaps themselves, or the bookcover.

Flaps (book “Windows”, or hatchbacks) themselves, could also be “held in place”, as well as “adjusted” (held open to varying angles, or degrees) by hook & loop fastener means, or plastic “knob & hole fastener strips” (such as those used to “conform” a baseball cap to varying head sizes); or any other “Flap holding & securing means”, possibly selected from the “Attachment Means List” below. Such means could “tie” (secure) open the “Windows” (Flaps) to one or more point(s) on the other Flap(s), and/or to point(s), or edge(s) of the bookcover. One anticipated securing method would involve “tethering” each deployed Flap to a securing point at, or near the bottom edge (on either the outer or inner surface) of the bookcover.

Another conceivable means for providing variable reclining support angles is via a “graduated stairstep” means, such as is used on some picture frames, and of similar (single-dimensional) appearance to that of a vertically ratcheting car jack. The angle is adjusted by placing the picture support strut (or bookcover Flap, or Flap strut) into selected, or successive notches in the stairstep, enabling the reclining angle to be correspondingly modified (increased or decreased accordingly).

The Flaps (“Windows”) could be attached, or mounted on articulating points, hinges, or axes oriented horizontally—i.e., “parallel to the bottom and top edges of the bookcover” (or, “perpendicular to the book spine”); or otherwise (at any number of various other angles), depending on the variables encountered. Such variables might include book size (both in page surface area, and number of pages), weight, and/or binding stiffness, and/or flexibility.

Flaps could conceivably support the book in a multitude of different configurations, and arrangements. All ramifications thereof are contemplated; and some may be more desirable than others for specific design considerations (anticipated desirable “target benefits”, mentioned earlier); or for the particular needs of certain consumers; and/or applications. Therefore, although this type of reclining support means is termed “Flap(s) or ‘Window(s)’;”—largely unrestricted construction, application(s), modification(s), or arrangement(s) thereof should be assumed. Interactive (Flap or “Window”) variables, which therefore, are presently left largely unspecified include: number, size, shape, articulating (hinge) point(s) (and/or angle(s)), placement, and deployment method(s) thereof.

For example, one Flap or “Window” embodiment might substantially resemble the hinged, “double L”-shaped, or “J-L”-shaped (generally plastic or wooden) support stands used to display decorative plates, pictures, or frames; or any other “presently detached” (separate, or independent) support means. By combining these with the bookcover, (with the appropriate Attachment Means), they could become substantially more convenient, or “readily available” to the user.

The bending, “folding” (or articulating) of the normal, or added bookcover in any manner to support books (of both common and uncommon construction), has been previously applied only to extremely narrow (relatively minor) page-binding (book construction) types, (i.e., spiral, or “lay-flat” bindings, and the “Crawford Display binder”). However, other folding methodologies could be used for books commonly—including the “diagonal cut” fold method shown in Draw. 3. Thus, “specially-folded” covers are also “covered” under the category “Flap(s) and ‘Window(s)’;” and may also be combined with other Reclining Support Means, as shown in Draw. 15.

Such embodiments (including the Flap(s) or “Window(s)”, and their associated components), and ramifications could incorporate any item(s) from the “Attachment Means” (see list, below) to interface, or articulate with the bookcover; with each other; and/or with the support surface(s), or object(s). The same goes for any other Invention embodiment, and/or ramification, whether or not shown in drawing(s), and/or specifically delineated.

Flaps could also be “reinforced” (braced), and/or have an applied (or inherent) non-skid edge or area to better “grab” (avoid book slippage) on the contact, or resting surface or object; and might have rounded (blunted, or cushioned) corners, and/or edges, for safety. Still, the shape of any Flap or “Window” could be variable (not exclusively square, or rectangular). Circular, or other design shapes might be utilized as well, for possible structural, aesthetic, advertising, or other purposes. Such shapes might be designed, cut, and/or decorated to resemble a character, or symbol, or object, or figure, or art associated with either the book itself, (i.e., its author, publisher, storyline, or subject matter); its promoter; its intended audience (or consumer target group); or any other object or entity.

Flap(s) or “Window(s)” could possibly be grasped (deployed) more easily by providing (finger-sized, or other-sized) cut-outs, or indentations (or convexities, or protrusions) in the outer bookcover (or Flap or “Window”) surface. Additional, or alternate grasping points might be provided by “Flap-extension tabs” (possibly somewhat resembling tab extensions (appliques) on binder paper divider sheets). Such extensions (of appropriate width) could protrude over the edge of the normal (underlying) bookcover, and provide an easy grasping point by which one could deploy one or more Flap(s) or “Window(s)” (see Draw. 5).

The outer (added bookcover) surface, together with its comprised Flap(s) or “Window(s)”, could be entirely transparent, or could be colored, and/or decorated, and/or printed, to match, or resemble the original (normal, or underlying bookcover) surface; or alternatively, a different design motif.

Finally, as with all Invention embodiments, and ramifications described herein, the Flap(s) or “Window(s)” (or other Reclining Support Means), as well as all support system sub-elements and components, could be completely removable, or detachable, by utilizing appropriate (selection(s) from the) “Attachment Means” list, (or similar item(s)).

And if interfaced with (integrated into) an “added bookcover means”, the Flaps could be either inserted into “pocket sleeves”, or “vents” (slits) in the cover—to effect the book's “reclining support” mode. Though described as “relatively flat”, all Flaps could be designed with permanently, or adjustably-angled, (or bendable) articulating axes, which would enable Flap sub-panels (sub-panes) to be angled, or folded completely upon, or over, with respect to each other. Such angling (articulations) might help to attach or interface the Flap to either the bookcover, and/or the resting surface; and/or alter the angle of reclination—providing a more universal, versatile, or secure “Reclining Support Means”.

Additional Embodiment

Inflatable, or Expandable Flaps, Pockets, Sections, Compartments, or Protrusions:

One embodiment “class” from this Reclining Support Means category envisions the Flap(s) or “Window(s)” just described, to “emanate”, or be deployed from the bookcover in an inflatable, or expandable manner. The inflation or expansion means might consist of gas, liquid, or solid; and/or any combination(s) thereof. For example, if expanded by gas, like separate balloons, or alternately, as interconnected air mattress compartments, each Flap, Pocket, Section, Compartment, or Protrusion (i.e., “expandable support means”) might be additionally weighted, or reinforced with solid(s), or liquid(s). The reinforcing solids (e.g., metal, mineral, plastic, fiber, wood, and/or composite, etc.) might be one piece (for example, a disk or plate, block, or cylinder, etc.), or alternately, an accumulation of smaller particles. A liquid “expansion and/or reinforcing means”, would likely be water; or possibly some other (hopefully “well-contained”) consumable, or relatively non-staining, volatile liquid.

The inflatable feature could be activated by gas (air from the user's lungs, or an alternate air pump); or, it could even utilize “self-inflating”, or “self-expansion” means. The “expansion feature” could also simply be mechanically activated (extended or “pulled out”) to the desired support formation, or position, much like the focusing compartment of an antique portrait camera; or an umbrella; or as with window curtains, or room-divider partitions (whose fan-shaped, or “accordion fold” design allows for easy expansion and contraction). The book support compartment too, could be folded, or not (simply crushed, or deflated after use).

Due to this “deflation capability”, the relative “bulk” of the “expandable support means” (for conformance to the existing book cover is not as critical a consideration as with Flap(s) or “Window(s) generally, since any “deflated” (unexpanded) cover could again substantially conform to that of the normal bookcover. Therefore, the “expandable support means” could include Flaps, Pockets, Sections, Compartments, Protrusions, pillows, projections or members of various, relatively unrestricted size(s), shape(s) or arrangement(s).

If desired, they could (like “Windows”), also be arranged into separate rows, or “tiers” (as described above), to permit the book to be reclined at varying angles—(by most likely inflating the same “supporting tier compartment(s)” on each half-bookcover). However, related embodiments might deploy, or expand “non-identical” compartments on both half-bookcovers—for aesthetic, and/or functional reasons; since balancing the book's weight, or center-of-gravity, or equilibrium dynamics, usually changes, as the pages turn.

Still, with “inflation or expansion cushioning” of these dynamics, it may be feasible to simply utilize a single compartment (stretching across the spine and cover). And although full inflation of this ramification might conceivably tend to overstress the spine (binding), this could be compensated for in the design of the compartment(s). For example, the compartment could have a “spinal loop”, which is actually “detached” from the surface (plane) of the cover itself (see Draw. 7). Or, the compartment side against (i.e., interfacing edge adjacent to) the bookcover could be somewhat “wedgeshaped” (whereby the pressure works to keep the bookcover from opening fully to a 180 degree planar configuration). Also, the compartment side impacting or resting against the supporting or reclining surface could also be wedge-, or bow-shaped, with possible similar effect(s). Thus, a top view outline of this embodiment's (ramification's) inflated compartment might tend to resemble the shape of a bow-tie.

Also, a “cover stabilizing (orienting & securing) means” (see below), could be utilized, whose straps, struts, or stops, etc. “set” the cover open at a specific angle; and/or help to prevent it from opening to a wider angle. Additionally, the user could counteract, or compensate for each book's (relative) spinal flexibility, by inflating to the “correspondingly appropriate” level.

Additional Embodiment

Forms or Objects (Balls, Blocks, Bags, Figures, etc.)—Including Those Which Are Filled, or Which Are Inflatable/Expandable:

These Reclining Support Means could allow the book to simply “rest upon” them, much like one might prop a book up against a pillow. The Forms or Objects (balls, blocks, bags, figures, etc.) could be made from any combination(s) of plastic, metal, rubber, wood, cloth, or any other appropriate material(s). They would likely be quite durable; but if desired, might also be made more cheaply, or “disposable”. They could be of relatively constant mass, form, and/or volume; or alternatively, be inflatable or expandable.

They could include, or resemble pillows, foam or soft rubber “stress” (relief) balls, or other “play” balls, or objects; bean or otherwise filled or cushioned bags, stuffed animals, toys, etc. They could also be completely detachable, and useable in one or more other (related, and/or unrelated) modes or functions.

This category also includes any existing, past, or future form, or object, or figure, which could be modified to function as a bookholder, as well! This includes “action-type figures”, dolls, stuffed animals, toys, etc., which already have alternate use(s). They could be the “Let me help you to hold your book (XX-name of Supporting Figure)” from the “Eager (or Easy) Reader” (Cast of characters)! They could be separate objects from the cover itself, (or not); and might attach to the book cover via hook & loop fasteners, snaps, suction cups, or any other “Form or Object, (or figure, etc.) securing means” (examples provided in the “Attachment Means List”, below). The bookcover itself could be outfitted with such attachment means or points, scattered in both, or either, the horizontal, and/or vertical directions (i.e., transverse, and/or parallel, with respect to the spine)—the latter of which could likely facilitate variable reclining angles. Other variably arranged, or distributed attachment points may be utilized for stability, or other desired design optimization(s).

Another alternative (ramification) would be for the “Form, Object”, (or figure, etc.) to have a “movable (and/or rotatable) member” which connects to the book—thereby facilitating an interface with variously-sized books, and/or enabling various reclining angles. To the same end, translatable, and rotating “Attachment Means” are envisioned possibilities for any Reclining Support Means.

Also, each Form or Object, (figure, etc.) might be additionally weighted, or reinforced with solid(s), or liquid(s). The reinforcing solids (e.g., metal, plastic, fiber, composites, or wood, etc.) might be one piece, or alternately, an accumulation of smaller particles. Finally, the “Form or Object” (figure, etc.) might have “suction cups”, “feet”, or “non-skid characteristics” added, or inherent to one or more of their sides, or portions of their surface area—to enable them to better “grab” the surface on which they, and/or the book rests.

Additional Embodiment

Members, Trusses, Frames, Containers, or Panels

These Book Reclining Support Means (this category), again, as with all Reclining Support Means, could be permanently attached to, or separate (detachable) from the original bookcover; (or, interface with permanent, or removable added outer bookcovers or slipcovers). Additionally, these Members, Trusses, Frames, Containers, or Panels may have “Attachment Means”, which themselves are permanently integrated, or separate (detachable) from the bookcover.

For example, if one was attaching the Members, Trusses, Frames, Containers, or Panels to an original (hard or soft) cover, they could connect to the bookcover edge via an “Attachment Means” which simply attaches, pinches, grabs, or slides over the top, side, and/or bottom edge of the bookcover (possibly including a “Support Foundation Means”, and/or a number of pages). Such “Attachment Means” could attach to the cover edge, much like an “alligator”, or binder, or clothespin-type clip; which in turn, could provide one or more additional Reclining Support “holding & securing means”.

“Multiple attachment means” might include grooved “I-beam” shaped frictional or spring- (or elastically-) loaded/tensioned connectors; similar to two binder clips back-to-back. Or, angled connecting means with “more than two groove (or holding)” capability—such as the “T”—shaped, slotted, or grooved member, which secures the “dime-store”, rubber-band powered, wooden airplane kit wings to the plane's “body”.

These bookcover edge “Attachment Means” could then provide one, or more additional “Attachment Means” (listed below) to secure any Member, Truss, Frame, Container, or Panel. For example, nubs, and casings—such as those used to interconnect flexible poles together, (as are used in small collapsible camping (dome) tents). Any such “Attachment Means” could additionally rest on (or provide, or be coupled with) a “flexible, or rotating joint means”—for helping to provide a variety of Member, Truss, Frame, Container, or Panel (and/or bookcover) support angles.

Members, Trusses, or Frames, etc. might be complex enough to resemble structural technologies used to support a house, or bridge; or simple enough to resemble the legs of a portable camera tripod, or bicycle kick-stand. They could be stiff, but somewhat flexible “struts”, such as the dome tent rods (mentioned above), or, they could include springs, or folding & extension means of any appropriate sort. One example of how two such (potentially telescoping) members might be joined on (by) a simple strap, or tether is shown in Draw. 13.

One embodiment might include one or more “bendable spring stems” (similar to those used in certain “shoe trees”), with an Attachment Means to the book(cover), and another (with possible “anchoring means”) to the resting or reclining surface.

There could be one (or more) Members, Trusses, or Frames used to support each half of the book cover—attaching to the top, bottom, and/or side edge of the covers (as just described). Or, they may be designed to attach anywhere on the bookcover, or each half-bookcover via a movable “Attachment Means”, such as clips, hook & loop fasteners, snaps, or suction cups, etc. Additionally, the Members, Trusses, or Frames could be “secured”, or “tied together” to a common or separate “member joining means” (e.g., a sleeve, socket, band, ring, or receptacle) which could “couple” the members to each other). Such member joining means may “tie” the members together at their ends (see Draw. 11); “crossing points” (see Draw. 13); or any other desired point(s).

A “surface anchoring means” (e.g., a means for securing the Member, Truss, Frame, Container, or Panel to the surface on which the book is reclined, might utilize suction cup(s), strap “tie downs”, weighted or anchored, sticky (tacky), or “surface grabbing” means, etc.). These “member joining means”, and “surface anchoring means” may, or may not be the same item, or object.

Also, one or more “C”-, or “D”-, or “other”-shaped Members or Frames (somewhat resembling the shape of a briefcase, or bucket, or boom box, etc. carrying handle) could attach to (or support) the bookcover in either a vertical manner (generally parallel to the spine); and/or in a horizontal manner (generally transverse to the spine); or at any other angle (with respect to the spine). Two or more Members or Frames might also intercalate (interconnect, or synergistically brace, or lock) with each other. Rotational (possibly ratchet-like, or locking) connecting or attachment means, could also provide variable reclining support angles.

“Containers” with Book Reclining Support Means might resemble variously designed VCR (video), or similar containers, with appropriate modifications. One such modification could include hinged panels (one or more on each “face” of the videocassette case), which could effect the “reclining” function. Also, a “bookcover, and/or page securing means” could “flexibly capture” each half book; (allowing “play” for those book(cover) bindings which require less than “fully flat planarity”.

Other plastic-type “Containers” (similar to those made by TUPPERWARE®, or RUBBERMAID®) might encase, or cover the book; yet be hinged, or “articulatable.”

These could have “Reclining Support Means” “built in”, or “integrated” thereinto; or they, themselves might function, or act as a “Form or Object” (Reclining Support Means)—having capability for being connected to the book via an appropriate “Attachment Means”. Still others might be “hybrid containers”, such as the “plastic” (video tape-type) containers above, but with a lid similar to (plastic) “storagecontainers”. And, still others might encase the book with top and bottom “compartments”—enclosing it much like the long, rectangular fireplace match cases; which, with “hinged” top, and bottom compartments; might be conveniently combined in a Reclining Support Means function. The articulated, opened “top”, could act as the “Flap”, or strut, to support the articulated, opened “bottom”).

Finally, coming full circle (back to Flaps), the Book Reclining Support Means might be achieved via a removable Panel. Such Panel(s) might be a “flap-like Curtain”, (which is not necessarily completely flat, or planar, but could possibly be reinforced with springs, rods, and/or other members; and/or folded like a fan or accordion. The Panel could attach to each half-bookcover, or over the entire cover. The Panel or “Curtain” could be flexible enough to bend around (compensate for) most bookcover opening angles, but stiff enough to support the book weight. Such flexibility might be afforded by “accordion-like” (or similarly acting) folds (or expansion means) in the “Curtain”. The “flexibility” feature, or characteristic therefore, might exist in primarily the “more horizontal” plane, while the “stiff, or supporting” feature, characteristic, quality, or means might exist primarily in the “more vertical” plane. Any of these “Panels” might “fold” normally with the book, when closed; or, if removable, be kept inside a slipcover pocket, or pouch; or possibly rolled up, or folded against the bookcover.

Another Panel embodiment might consist of simple single, or hinged double “sheets” (or support planes), which largely, or substantially provide a “support foundation” (see “Support Foundation Means” section, below) for each half-bookcover. The single sheet, (or one side of a hinged double sheet), could then itself act as an articulated flap; or have (incorporate) such flaps; or have other reclining support means attached, or integrated thereto.

Conclusions, Ramifications, and Scope

To Recap, the Book Reclining Support Means could be mainly comprised of one or more items from one or more of the following support “categories”; and may include any combination(s) thereof (i.e. mixed arrangements of these Book Reclining Support Means):

Flaps, or “Windows”;

Inflatable/expandable Flaps, Pockets, Sections, Compartments, or Protrusions;

Forms or Objects (balls, blocks, bags, figures, etc.)—including those which are filled, or which are inflatable/expandable;

Members, Trusses, Frames, Containers, or Panels

Multiple configurations, embodiments (or ramifications) of the above Reclining Support Means categories, are foreseen to likely be useful—so as to provide “reclining and viewing support” (and enhanced hands-free) benefits to the wide-ranging needs of reader or viewer population(s); and to account for the different types of book, and bookcover designs.

No restriction should be imagined for any Reclining Support Means, (or Book Reclining & Viewing Support system, sub-system, or component) make-up, or material(s). Plastic, foam, wood, metal, synthetics, composites, rubber, organic-type material(s)—including plant or other fiber(s), leather, hide, etc., fabric, etc.; or, any combinations thereof are all deemed possibilities. Choices might be based on strength, durability, functionality, feel, artistic style(s), and appearance—along with manufacturing, and cost considerations.

There should also be numerous methods/means for modifying, or manufacturing bookcovers with appropriate “Support Foundation Means” and/or “Attachment Means”, or elements thereof.

### Support Foundation Means

Any of the above Book Reclining Support Means might articulate, interface, or attach to new, or already-manufactured book covers via permanent, semi-permanent, or removably mounted “Support Foundation Means”. Many alternative “Support Foundation Means” are envisioned; and it is anticipated that those which result in the quickest “deployment” and “disassembly” (set-up and collapse) of the above Book Reclining Support elements, will probably be the most acceptable, or successful with users; provided that other design considerations (“target benefits”) are sufficient.

The “Support Foundation Means” is simply the structure, and/or surface, and/or mechanism by which the book (bookcover) is fortified or enabled to receive the Book Reclining Support Means; and endure the dynamics associated with the usage thereof. Such Foundation means, or elements thereof, could be more permanently “built-in” to future bookcover designs. Permanent, semi-permanent, or removable “Support Foundation Means” could also be “added” via added, or “slip”—cover designs to any existing book. The “Support Foundation Means” may include any one, or more (including combinations) of the following, or similar items:

Attachment Means (permanent, or removable),

Binder-type covers (with a “book retaining/securing means),

Containers, or Panels (mentioned in the section above),

Covers/Plates, Single, with attachment means—such plates or sheets may cover just the outer surface of the original bookcover, and be attached to the book via any Attachment Means noted in the list below,

Covers/Plates, J-shaped—or, a panel with a curved “trough” in which the book(cover) may rest. A large trough could include the bookcover, or half-bookcover, and some or all of its associated pages.—see Draw. 27.;

Covers/Plates, V-shaped—(hinged plates, or covers) which partially, substantially, or completely cover (enclose) the half-bookcover's surface.

Covers, Complete (which completely enclose either the entire book, or the entire bookcover; or primarily the outside surface of the bookcover).

Decals,

Disks—permanent, or removable (possibly attaching and/or detaching similarly to those electro-magnetic signaling means, used to protect goods in retail, or department stores),

Reinforcement surfacing added to a bookcover (including laminated, appliqued, painted, contact (self-stick), or other layered, coated, or applied sheeting, and/or surfaces).

The strength, flexibility, and type of each Support Foundation Means, if needed, might be gauged by whether the book is hard- or soft-cover; also, its surface area, and weight. They therefore could be of any type of material, and constitution (flimsy, or firm); and may of may not include other Reclining Support Means components. Also, more than one Support Foundation Means (e.g., one flimsy, one firm; one large, one (or more) small(er); etc.—or any other combination of these—for “surfacing” and/or “functional” purposes is anticipated).

Many books may, or may not require a separate Support Foundation, per se—so long as an appropriate foundation or surface interface is integrated, coupled, or designed into the Attachment Means List item(s) (listed below):

### Attachment Means

Sample ideas, methods, or means for “interfacing” any Invention elements, might consist of any one, or more of the following (or similar) items; or any combination(s) thereof. They include means for “securing”, “anchoring”, “connecting”, “joining”, and/or “tying down” Invention elements, or components; and may include related items (i.e., this list is not all-inclusive, but instead a “representative sampling”):

Adhesive (including reusable types, similar to that on yellow “sticky tags”),

Band, or Belt (rubber, or other flexible, or elastic material),

Bolt (& nut, or retainer),

Buckle,

Button,

Chain,

Clip (alligator, binder, clothespin; or retainer),

Connector (with or without spring action),

Crimp,

Cylinder & dowel,

Fitting (e.g., molded, pressure-activated, frictionally-adhering),

Frictional enhancers (surfaces, or items, including painted, rubberized, plastic, etc. strips, pads, edges, covers, and/or components), which reduce slippage on a resting, or contacting, or adjoining surface,

Hinge,

Hook,

Hook & loop fasteners,

“Knob & Snap-hole” strip (such as those used to adjust baseball caps to one's head size),

Knot (or Tying),

Latch, and/or Lock,

Loop (possibly with sliding keeper—similar to suitcase straps),

Magnetic-type (retail goods) security lock, or fastener,

Nub, and hole (rotating joint),

Pin (insertion, retaining, safety, etc.),

Ratchet, (either stairstep/planar, or circular),

Rivet,

Rotational (axle, or ball bearing, etc.),

Sewn, (stitching),

Sleeve,

Snap,

Socket (including ball & socket),

Solder, or Weld,

Spring,

Staple,

Strap, or Tether—including all cloth, plastic, leather, natural, or synthetic material(s)—flat, or round, of any appropriate length, and dimension (width, or diameter),

Suction cup,

Tab, insertion, and/or locking,

Tape, including “wall-mounting strips” (such as is used for attaching pictures, hooks, etc.); and including permanent, semi-permanent, or removable),

Thermal bond,

Threaded (screw, or twist-action joints),

Zipper (including disposable freezer or food storage bag types)

Again, the above, or similar Attachment Means items could also be combined for optimal functionality. For example, a clothespin-like clip, could be combined with a “rotating, ratcheting means”. The clothespin-like clip could connect to the bookcover, and the rotating, ratcheting, (or retainer-type) clip could hold a “C”-, or “D”-, or similar support frame (which may, itself require, or utilize an “Attachment (or joining) means” in its “midsection”—allowing the C/D frame to approximately conform to the book's edge when closed (see Draw. 16).

Thus, the Book Reclining Support Means (main Invention elements) could be employed, and complemented by any of the above “Attachment Means”, and/or “Support Foundation Means”, to enhance functionality, safety, fit, stability, strength, usability, and quality; also, to help to minimize wear-and-tear.

### Supplementary Enhancements & Implied Options

Any of the above embodiment combinations could also be enhanced, or supplemented by any one, or more of the following complementary features . . . (in fact, they are largely implied options for every appropriate application—though they may not be included in embodiment or ramification drawings, and/or descriptions):

“cover stabilizing (orienting & securing) means”;

“Page securing means”;

“environmental protective means”;

“book carrying (transporting) and/or storage alternative means; and

“alternative display or support means”.

Cover Stabilizing (Orienting & Securing) Means:

These means could help to support the book cover opening angle; and help to relieve book spine stress. They could consist of hook & loop, or “knob & snap-hole fastener” strips (such as those used to secure baseball caps to different-sized heads); and/or any modified (likely highly reusable/reconnectable) Attachment Means (just mentioned). Such cover stabilizing (orienting & securing) means could attach or connect to (or link) the top, side, and/or bottom edge(s); and/or the sides or surface areas of both half-bookcovers; and/or attach at one or more points across the book spine itself. An illustration of how such a strap might “double” as a book carrying strap is illustrated in Draw. 39.

Enhanced cover stability (for the book's viewable, or open position) could also be achieved by positioning, spanning, or attaching any “connecting means” (e.g., member; or Attachment Means, etc.) across, or between the two covers (most likely in a less than “fully flat”, or <180 degree planarity). One ramification might utilize “beltloop-like” holders on each half-bookcover, through which the (slightly, or appropriately curved) “cover stabilizing” (and/or supporting means) might be threaded. Another method would involve simply a “retaining” or supporting strap suspended between the two covers, or across the spine.

Page-Securing Means:

Page-securing means could be utilized to help to keep the pages lying relatively flat (assisting or facilitating a more planar viewing surface) for the reader or viewer. These means could be comprised of “straps” (such as hook & loop fastener strips; knob & snap-hole fastener strips or bands; nylon strips or bands, etc.), which could secure pages on each half-bookcover. They might be placed, or located near the edge—covering primarily only the “relatively blank” areas—(i.e., those comprising the corners, and/or margins of each page).

These page-securing means could also be comprised of large, (likely clear) “photo corners” (constructed similarly to those used to mount pictures in a photo album)—which hold either, or both the top and bottom corners of each page to the cover. Or, they could even be flexible, or spring-loaded “stays,” or clips (similar in appearance to those used on pens, or mechanical pencils); or stationary, or rolling “balls” (or wheels) attached to the cover, which one simply lifts, and slides each page under, as they are turned. These flexible, or spring loaded type stays could also be rotate-able (away from the page surface), such that they would not interfere with the turning (flipping) back and forth of many pages at once.

Environmental Protective Means:

Environmental protective means could probably be afforded by a durable cover (either permanent or removable); and possible “protective flaps”, which could cover the book edge(s) themselves, when the book is closed. These same “protective flaps” could also function as “Reclining Support Means holding sleeves”; and/or as “tethering points”, with rivets, snaps, or fastener means—(for securing Flaps, or “Windows”, or other Reclining Support Means); and/or as surface-gripping, anti-skid, or book stabilizer means (i.e., serving multiple functionalities).

The environmental protective means feature could be incorporated via a cover constructed to partially, or completely enclose the book. Such a feature might readily be recognized in the VCR/video tape case (and other “Container” type Support Means, mentioned earlier).

Also, slipcovers, or carrycases could increase the capability to improve the book's protection from handling, environmental, and/or weather damage, or wear-and-tear.

Book Carrying (Transporting) and/or Storage Alternative Means:

Hook & loop fastener, or “knob & snap hole”, or other “tethering”, or “tie-down”, or “securing” means (see Attachment Means list above), could double in function as a carrying and/or transporting, and/or storage alternative enabling means. For example, by holding the two half-bookcovers together, and creating a “handle” (or loop) between them—whereby the book may be carried, or hung.

Alternative Display or Support Means:

An additional, appropriate embodiment might involve adding hooks, clips, holders, or other appropriate “Attachment Means” to the bookcover, or other Reclining Support Means; (e.g., by tailoring the “top tier” of a Flap(s) or “Window” embodiment) such that the book could then be suspended over a car window, or modular room partition, drawer, baby crib member (top rail), or a wire, rope, or other “suspension means”. This alternative display or support means differs significantly from those Reclining Support Means which entail resting the book primarily on a generally horizontal plane, or surface.

Also, one might use a strap, tether, or other Attachment Means to secure the book against a pole, post, or other Reclining Support surface, (other than a “horizontal resting plane” or surface).

Function doubling securing features (e.g., straps which “double” as both “page securing means”, and/or book carrying, and/or storage, and/or “alternative display or support means”, for example), could be facilitated by the appropriate use of sliding, or rotationally-enabled Attachment Means—which provides a plurality of attachment (connection or fastening) points.

### Book Reclining Support Method Embodiments, & Ramifications

A “quickly deployable”, and “easily portable” support solution; together with unique Reclining Support Means, and methods; particularly those which provide a wide horizontal support base; (and/or a low center-of-gravity), will likely improve this Invention's support stability, acceptability, and applicability over prior solutions!

Elements of all Invention embodiments may be made from plastics, foam, wood, metal, synthetics, composites, rubber, organic-type material(s)—including plant or other fiber(s), leather, hide, etc., fabric, etc.; (or similar materials)—or any appropriate combination(s) thereof. The types of possible appropriate materials are substantially unrestricted/ unlimited—provided that they are fit for human handling (i.e., safe/non-toxic) in final form.

As mentioned above, “time is of the essence”, and therefore, each Invention embodiment should be designed, manufactured, and implemented to (eventually, or in the end), provide opportunity, characteristics, or means for quick “set-up”, and/or “repositioning” of the reading, or viewing materials (including the adjustment(s) of viewing angle(s), or reading position(s)); as well as “disassembly/ collapse”, or “return” (to a “closed book configuration”).

Also, it is intended that any and every embodiment and ramification could include appropriate sub-elements (taken from the “Attachment Means List”, and/or “Support Foundation Means” sections (above); including other functionally similar items).

Also, it is intended that embodiments could be made or designed with removable or replaceable components; or that subsets thereof could be incorporated into a removable, or replaceable panel; or, into a completely removable, or replaceable cover.

Finally, it is noted that some Embodiments or Ramifications may include NO Reclining Support Means at all—but may simply consist of a “cover stabilizing (orienting & securing) means”, or one, or more of any of the proposed “Supplementary Enhancements & Implied Options”, namely:

“cover stabilizing (orienting & securing) means”:

“Page securing means”:

“environmental Protective means”:

“book carrying (transporting) and/or storage alternative means; and

“alternative display or support means”.

Therefore, every possible combination and permutation of components should be considered viable.

Preferred Embodiment:

The primary design consideration, (aside from support stability, human factors, durability, and quality), should be implementation time (deployment speed of the book reclining support means). This is because we live in a very time-conscious, and interrupt-prone society; and the living pace of the world seems to be continually accelerating. This is observed by the proliferation of conveniences, businesses, and services which are designed or geared to satisfy the 24-hour, or “instant” or “immediate” (and capricious) market demands of “customers on the go”. Thus, the Book Reclining Support designs which are the fastest in “set-up”, “repositioning” (of viewing angle, or reading position), and “disassembly/collapse”, or “return” (to a “closed book configuration”) may very well be regarded as the most promising.

It is anticipated that the preferred embodiment will include a Support Means with a fairly wide “contact base” (or “span of contact”) with the book(cover), and possibly with the supporting surface(s) (and/or object(s)) as well!! In other words, many prior solutions have resulted in “potentially imbalanced” support configurations, due to possible rotational moments realized around the support or “fulcrum point(s)”—particularly evident as large numbers of pages are turned in one or another direction.

More stability might therefore be realized by having the Reclining Support Means contact or interface with each half-book(cover) at one or more points from approximately the middle of each half-bookcover to the outer edges (moving horizontally). However, this “span of contact” or “interface area” could be adjusted, depending on the weight, and construction characteristics of the reading or viewing materials (i.e., hard or soft-cover; number of pages; strength of cover and/or binding, etc.). Of course, any additional contact or interface points (lines, and/or surfaces) may, or may not be included for enhanced support. Also, a relatively “widely spanning resting base” (or “footprint”) with the supporting surface is likely desirable. Any scheme, which “lowers”, or “keeps sufficiently low” the center-of-gravity would likely be preferred. It is anticipated that the use of multiple, widely based “supporting points” would be preferred over the “three point”, or “tripod”; or, relatively narrow-based types of support seen in so many prior solution attempts—and which are apparently susceptible to a rotational moment problem.

To recap, the “Preferred Embodiment” would likely include:

1. Ability for quick deployment (and collapse) of the Reclining Support Means;

2. Relatively widely-spaced (or large interfacing) areas between the widest contact, or interfacing points of the Reclining Support Means (attachment points) with the bookcover (one or more “closer” support points may be desirable, as well);

3. Relatively wide “footprints” (incorporated surface area) between the impact, interface, or resting points of the Reclining Support Means (as well as the book itself), with the resting/ supporting surface;

4. Minimized rotational moment problems—which, if not accomplished through #2, and/or #3 above, may require, or suggest that the Reclining Support Means interface with the bookcover, so as to help maintain a relatively low center-of-gravity;

5. Reclining Support Means which largely conform to the shape or form of the book; or are easily configured to, and transported therewith.

6. Provides attractive, and/or desirable “reclining/ viewing”, and unsupported/collapsed configurations.

The Preferred Embodiment may actually therefore include various forms—whose general aim is to fulfill the advantages listed above. At present, it is anticipated that tiered Flaps or “Windows” would best fulfill these goals for general (most common) applications.

However, various other versions (of proposed Invention Embodiments & Ramifications) may also be “preferred”, depending on the target audience (i.e., kids may prefer “dual functionality Reclining Support Means”, such as “toys”, dolls, and/or figures (functional or decorative); while teens or young adults may prefer the dual functionality of “stress, sport, or (foam-like, bean-bag-like, or rubber-like) exercise balls”, etc.). On the other hand, people who travel, or carry their reading/visual materials around a lot, may prefer the added protection of a video-cassette-like, (or container-like) protective case; with an inherent, integrated, or attachable Reclining Support function.

### Partial (“Representative”) List of Embodiments & Ramifications

All embodiments, and ramifications (alluded to in the prior narrative descriptions), may include one or more of the following Reclining Support Means—as well as any, and all appropriate combinations thereof:

Flaps, or“Windows”:

1. One or more Flaps or “Windows”, which extend across all or part of the width of each half of the bookcover; being hinged, and opening on a generally horizontal axis (perpendicular to the book's spine); and which may, or may not be organized into “tiers”, or rows of equal or unequal “window” height, or size.

2. Same as in #1, but which are hinged, and opened or articulated on other than generally horizontal axes—including vertical, or skewed axes, relative to the book's spine.

3. Flap(s) or “Window(s)” which open across the entire bookcover (including the spine)—with, or without an additional horizontal expansion means (and/or spinal compensation means), which allows it to be more easily or effectively folded around the spine (more than gutters).

4. Flap(s) or “Window(s)” which are interleaved, such that by opening, or deploying certain Flap(s), that one or more smaller Flaps (which are contained within it, or which help to comprise it) are deployed as well. Such interleaved flaps may be hinged or articulated parallel to the spine, and/or at a transverse, or skewed angle thereto. The flaps might also be articulated at the same, or mixed angles, with respect to each other (see Draw. 4).

5. Flap(s) or “Window(s)” which are added to a bookcover via an appropriate Attachment Means; and which may prop the book in a manner similar to any photo frame support(s), strut(s), and/or stabilizer(s).

6. Movable Flap(s) or “Window(s)”—whose hinged or articulating axis, or axes is not locationally restricted (i.e., may be along any edge (top, bottom, or side); or anywhere else that such articulation would be desirable).

7. Generally vertically-hinged or articulated Flap(s) or “Window(s)”, which form a general ‘V’-shape, or somewhat triangular, or modified “Flying Wing” shape with respect to the bookcover (as viewed from above the top edge of the book); with the opened book(cover) and pages forming the inside (acute) angle, and the Flaps the outside (acutely-angled perimeter) of the “Flying Wing” (the top of the book spine located analogously to the Flying Wing's cockpit.

8. Similarly hinged, or articulated flaps to the “Flying Wing” conformation, above; but where the Flaps are elongated, and “intercalated”, or “interlocking” with each other.

9. V-hinged (or Flying Wing-shaped) Flaps, wherein the Flaps themselves are hinged, or able to articulate (or be partitioned), to provide “angled edge(s)” with respect to the support surface—and thus, different reclining angles.

10. Flap(s) or “Window(s)” which themselves contain {or are partially constituted of}, other Flap(s), or “Window(s)”.

11. Flap(s) or “Window(s)” which may imitate, resemble, or function similarly to decorative plate stands (such as a “J-L” wing-shaped support stand).

12. Flap(s), or“Window(s)”, which provide variable reclining support angles via a “graduated stairstep” book(cover) interfacing means.

13. Flap(s) or “Window(s)” which are designed to open (be deployed), and interface with each other, and/or the bookcover, in more than one support configuration, and/or design arrangement.

14. Flap(s) or “Window(s)” which can articulate within themselves (somewhat like hinged accordion-folded shutters); and which can be temporarily “frozen”, or angled, into two or more “panes” of equal, or unequal size. Such angling may be desirable to enable more Flap surface area to interface with the book, and/or the support surface(s).

15. Flap(s) or “Window(s)” whose panes (sections thereof) may be placed into a bookcover holding, or interfacing means (i.e., interfaced with the book using an appropriate “Attachment Means”), to provide various book reclining angles; and possibly a better {or expanded} interfacing area with the reclining support surface(s).

16. Flap(s) or “Window(s)” which can be removed, and stored, or carried (generally via an appropriate “Attachment Means” with the bookcover; or inside a removable, or slipcover pocket or compartment, etc.).

17. Specially-folded (bent, hinged, or articulated) normal, or “added” bookcovers, such as the aforementioned “diagonal sandwich fold” embodiment.

18. Specially-folded covers, or “outer layer” of cover, which folds/articulates, and also enables other Reclining Support Means (e.g., members) to be connected thereto.

any Flap(s) or “Window(s)” may be of any appropriate size, shape, design, decoration, texture, appearance, and material(s). Such decoration, shape, or design might resemble a character, symbol, trademark, or entity, associated with the book's content, author, publisher, promoter, target audience; or any other item.

any Flap(s) or “Window(s)” may be comprised of two or more articulating areas—one of which may be positioned so as to increase, or maximize the interfacing area with the support surface; which interfacing area might also be coated, or augmented with a “frictional enhancing” or substantially “non-skid” coating or material.

any Flap(s), or “Window(s)”, or the bookcover could be modified to include “moldings”, or protruding ridges, or wedges, or straps, tethers, or “Attachment Means”, which effectively “stop” the Flap(s) or “Window(s)” at a desired, or appropriate opening angle. These, or other “Attachment Means” could also provide means for linking or connecting the Flap(s) or “Window(s)” together (to each other), and/or to any point on the book(cover) for better support angle(s), and/or system stability.

any of the above Flap(s), or “Window(s)” could have “grasping points”, or finger- (or other-) sized cut-outs, or “lips”, and/or “extension tabs” which make for easier “deployment”; and also whose edges and corners could be “blunted”, or “cushioned” (for safety);

any Flap(s) or “Window(s)” may be covered with a “gripping” substance or means which enables the Flap(s) or “Window(s)” to help avoid slippage on the resting or supporting surface(s).

any of the above embodiment elements could be additionally weighted or reinforced with solid, or liquid matter.

Inflatable/Expandable Flaps, Pockets, Sections, Compartments, or Protrusions, (All Generally Referred to by the Term “Expansion Means”)

19. Any of the above, or other related, similar, or derivative embodiments, whose Flap(s) or “Window(s)” are deployed from the bookcover in an inflatable, or expandable fashion.

20. “Expansion Means” running in rows, or tiers; which, when separately enlarged (deployed), can provide variable reclining support angles.

21. Variously shaped, and arranged, “Expansion Means” of any desirable configuration—{which do not necessarily, or may, or may not constitute “mirror images” between the two half-bookcovers}.

22. One or more “Expansion Means” extending across portions of both half-bookcovers, and/or the spine.

23. “Expansion Means” which have (incorporate), or employ a concave, wedge- or bow-shaped interfacing edge, or profile (with the bookcover, and/or the reclining support surface); which may help to support the book at a less than fully open (flat) cover position—thereby helping to relax or lessen “spinal pressure”.

24. “Expansion Means” which utilize mechanical movements, and/or mechanisms; similar to that of an umbrella, or of folded, accordion-type room partitions; or any other mechanically expandable structure, frame, member, or collection or combination thereof.

The “Expansion Means” for all of the above embodiments and ramifications thereof could be solid, liquid, gas; or simply mechanical; or any combination thereof.

The “Expansion Means” may be of any appropriate size, shape, design, decoration, texture, appearance, and material(s). Such decoration, shape, or design might resemble a character, symbol, trademark, or entity, associated with the book's content, author, publisher, promoter, target audience; or any other item.

The “Expansion Means” may be positioned so as to increase, or maximize the interfacing area with the support surface; which interfacing area might also be coated, or augmented with a “frictional enhancing” or substantially “non-skid” coating or material.

Appropriate “Attachment Means” could help to provide for linking or connecting the “Expansion Means” components to each other, and/or to any point on the book(cover) for better support angle(s), and/or system stability.

Any portion of the “Expansion Means” could have “grasping points”, or finger- (or other-) sized cut-outs, or “lips”, and/or “extension tabs” which make for easier “deployment”; and also whose edges and corners could be “blunted”, or “cushioned” (for safety);

Any and/or All “Expansion Means” may be permanently integrated into an original or added bookcover; or interfaced therewith via an appropriate “Attachment Means”.

Any of the above embodiment elements could be additionally weighted or reinforced with solid, or liquid matter.

Forms or Objects (Balls, Blocks, Bags, Figures, etc.)—Including Those Which are Filled, or Which are Inflatable/Expandable;

25. Any Form(s) or Object(s), which may have distinct utility “by itself”, or “by themselves” (in their separated state). Such utilitarian functions might include stress, exercise, or sports balls; containers (including those capable of holding drinks, tools, supplies, etc.); toys; dolls; “action” or still figures; stuffed (or inflatable) items, figures, or cushions; etc. Any Form(s) or Object(s) may or may not be designed to hold or carry specific objects appropriate to the “Reclining Support System”, and/or the target audience (i.e., writing instruments; student supplies; etc); or may simply have “generalized utility”.

26. Any Form(s) or Objects(s) which have no distinct utility, other than supporting, or propping the book (e.g. pillows, cushions); but which may, or may not be “artistically” or otherwise attractively decorated.

27. Any Form(s) or Object(s), such as those above, which may or may not be specifically modified for the Reclining Book Support function. Many items could simply be connected to the book via an appropriate “Attachment Means”, while others may be “split in half”, and/or specifically reinforced to interface with each half-bookcover.

Any Form(s) or Object(s) may interface with the bookcover (or half-bookcover) at a single, or multiple interface points; and utilize any appropriate “Attachment Means”; which may or may not afford multiple reclining angles.

Any Form(s) or Object(s) which could additionally incorporate, or be integrated with an inflatable/expandable function, or means;

Any Form(s) or Object(s) may be of any appropriate size, shape, design, decoration, texture, appearance, and material(s). Such decoration, shape, or design might resemble a character, symbol, trademark, or entity, associated with the book's content, author, publisher, promoter, target audience; or any other item.

Any Form(s) or Object(s) may be positioned so as to increase, or maximize the interfacing area with the support surface; which interfacing area might also be coated, or augmented with a “frictional enhancing” or substantially “non-skid” coating or material.

Appropriate “Attachment Means” could help to provide for linking or connecting the Form(s) or Object(s) components to each other, and/or to any point on the book(cover) for better support angle(s), and/or system stability.

Any portion of the Form(s) or Object(s) could have “grasping points”, or finger- (or other-) sized cut-outs, or “lips”, and/or “extension tabs” which make for easier “deployment”; and also whose edges and corners could be “blunted”, or “cushioned”;

Any Form(s) or Object(s) may be permanently integrated into an original or added bookcover; or interfaced therewith via an appropriate “Attachment Means”.

Any of the above embodiment elements could be additionally weighted or reinforced with solid, or liquid matter.

Members, Trusses, Frames, Containers, or Panels

These embodiments, and ramifications thereof, may include one, or more of the following; or any combination(s) thereof:

28. “Dome tent-like” member(s), and casings (cylinders).

29. “Bicycle-like” kick stand(s).

30. “Picture frame-like” strut(s) or support(s).

31. “Camera tripod-like” strut(s) or support(s).

32. Springs.

33. “C”-, “D”-, or other-shaped members, or frames.

34. VCR-, or “video tape-like” containers;

a. which may have one or more tiers of articulatable Flaps or “Window(s)”

b. Which may have any other appropriate Reclining Support Means joined thereto—i.e. the VCR-type container would simply act as the “Support Foundation Means”.

35. Panel(s), or Curtain(s) (with, or without accordion-like, or similar, or other flexibility, and/or extension means).

36. Simple “approximate half-bookcover” panels, which fold down (or up), from the top (or the bottom);—at one or more articulating points—much like flaps.

37. Notebooks, writing tables, etc. combined with any of the Reclining Support Means previously mentioned, or in any other embodiment, or ramification—with or without a specific “book accommodation” feature;

(* Note: “Books” per se, comprise only a subset of this Invention's applications or uses. Although books are envisioned as the primary application, embodiments of this Invention may be utilized to support other bound (and even unbound) materials, including: printed pages; photographs; artwork; drawings; music; assembly, maintenance, repair, or operating instructions; and word processing, typing, or data entry materials, etc.—which might be contained, or secured by albums, magazines, workbooks, notebooks, clipboards, dayplanners, manuals, writing tables or folders, portfolios, and binders, etc.; and protective covers for such . . . in addition to books).

Therefore, any of these items may be modified to specifically support themselves and/or books, for viewing! (i.e., a writing table (with a reclining support means; and appropriate “Attachment Means”) could itself hold, support, or prop a book (or similar item) for viewing. The book (or similar item) itself, in this case, may or may not have a reclining support means associated with it, since the writing table, or similar item, could perform that function.

any of the above embodiments and/or ramifications thereof could be “tied together” with a “joining means”—which might include any sleeve, socket, or receptacle which secures the support means to each other, and/or the supporting surface(s).

any of the above embodiments and/or ramifications thereof may be of any appropriate size, shape, design, decoration, texture, appearance, and material(s). Such decoration, shape, or design might resemble a character, symbol, (trademark) or entity associated with the book's content, author, publisher, promoter, target audience—or any other object or entity.

any of the above embodiments and/or ramifications thereof may be positioned so as to increase, or maximize the interfacing area with the support surface; which interfacing area might also be coated, or augmented with a “frictional enhancing” or substantially “non-skid” coating or material.

appropriate “Attachment Means” could help to provide for linking or connecting components of any of the above embodiments and/or ramifications thereof to each other, and/or to any point on the book(cover) for better support angle(s), and/or system stability.

any portion of the above embodiments and/or ramifications thereof could have “grasping points”, or finger- (or other-) sized cut-outs, or “lips”, and/or “extension tabs” which make for easier “deployment”; and also whose edges and corners could be “blunted”, or “cushioned”;

any portion of the above embodiments and/or ramifications thereof may be permanently integrated into an original or added bookcover; or interfaced therewith via an appropriate “Attachment Means”.

any portion of the above embodiments and/or ramifications thereof could be additionally weighted or reinforced with solid, or liquid matter.

Supplementary & Complementary Features

With respect to any Reclining Support Means, any of their embodiments, ramifications, or elements thereof could also be enhanced, or supplemented by any one of more of the following complementary features . . . (In fact, they are implied options for every appropriate application—though they may not be included in embodiment or ramification drawings, and/or descriptions):

Support Foundation Means (containers or panels; covers/plates of any configuration; decals; disks. )—see previous list);

Attachment Means (see previous list);

“cover stabilizing (orienting & securing) means”—which may connect, or attach between the two half-bookcovers—or between the support means themselves; which may help to secure or maintain the book (bookcover) in a specific angle of opening; and/or helps to relieve, or exert the appropriate level of stress on the spine, and/or binding. Such features may be incorporated into any Reclining Support Means, as illustrated in Draw. 38 (for Panels, and/or Flaps, etc.).

“page securing means”,—which may include any one, or more of the following (including combinations thereof):

photo corner-like holders;

tethering straps;

spring-activated, (clothespin, or hairpin-like clip(s)); or other “flexible stays” (e.g. “ball & arm”, etc.); see Draw. 41;

any other Attachment Means item (see previous list);

note: any of the above may be augmented with any frictional enhancing means to better “grip” (hold) the underlying page(s).

“environmental protective means”—including carrycases, containers (similar to video tapes, or any other storage-type container), or any protective cover/shield over the original bookcover, and/or pages (“page-covering” flaps, or panels);

“book carrying (transporting) and/or storage alternative means;

alternative display or support means, including hooks; flaps; frictional enhancing strips; or flaps (possibly with two or more articulating areas; or straps—to secure book against other than a relatively horizontally flat supporting surface (e.g. wall; pole; window (of car/vehicle, train, dwelling, etc.); any other “neighboring object”.

Note: any of the above supplementary items may be able to fulfill dual functions (e.g., a strap used as a book, or page-securing means might also be utilized as a book carrying or transporting means), etc.

Final Assessment

It has been conclusively shown how a reclining support means can effectively be interfaced with book, and bookcover designs. This reclining support function may be added to vast arrays of books, or “bound materials”;—defined by this Specification to mean “a plurality of leaves joined together with a cover means at any common edge.” Though many elements of angular book support have been tried, no other invention has delineated, or recognized the critical psychological nuances, or factors regarding the effects of optimized angular displacement of reading, study, or printed materials, to mental information processing (perception and cognition factors); nor how to “effectively combine,” or integrate such (precisely, or optimally oriented angular support) into the normal book (structural, configurational, and usage) profile—for both lay-flat, and non-lay-flat binding types. In addition, simplification is stressed, in order to provide a cohesive, convenient reclining function as part of a total book, bound material, or bookcover system. It is, in fact creating a new book, bound material, and bookcover system paradigm—much like how wheels have been cleverly integrated into luggage systems, and kid's recreational shoes—in order to couple rolling motion more accessibly and conveniently thereto. In like manner, Book* Reclining & Viewing Support technology can make “hands-free,” “optimally-angled” book viewing more widely available.

1. A method for conveniently stabilizing books, or bound materials, of both lay-flat, and non-lay-flat binding types or configurations, together with the page-viewing plane thereof, and the binding or spinal axis around which pages or leaves are turned, at one, or a plurality of tilted viewing angles from the generally horizontal support surface, of which at least one corresponds to that which is conducive, or is commonly used for normal, or general scholastic, or office desk study posture, and which provides a viewing plane more perpendicular to the line-of-sight; comprising:
(a) providing a reclining support means or structure, which:
1) conveniently, and substantially conforms, or bends, to the book's, or bound materials' open and closed configuration, while still substantially attached, or integrated thereto;
2) upon collapse, or disengagement, can be transported with the closed book or bound materials while still substantially attached to, or integrated to the book, binding, cover, or cover assembly;
3) provides a stabilizing capability spanning approximately half of the width of the cover, or more, whereby rotational moment forces about the spinal axis, or any deployed spinal strut axis, are counteracted;
(b) providing as needed an appropriate interfacing means, for joining said reclining support means to the book, binding, cover, or cover assembly, provided that said reclining support means is not actually part of the cover surface itself; including one or a plurality of the following:
1) an attachment means, as defined in this specification,
2) an additional cover, or cover overlay, or slipcover, or appropriate portion thereof,
3) a support foundation means, as defined in this specification.

2. The book or bound materials stabilizing method in claim 1, wherein said reclining support means consists of one, or a plurality of the following, or equivalent: permanent, or removably-attached articulatable flaps, wings, or window-like portions of the surface of the bookcover, or of an integral, or added layer or surface, thereto, or portion thereof.

3. The book or bound materials stabilizing method in claim 1, wherein said reclining support means consists of one, or a plurality of the following, or equivalent: permanent, or removably-attached inflatable/expandable flaps, or pockets, or sections, or compartments, or protrusions; any of which may, or may not articulate.

4. The book or bound materials stabilizing method in claim 1, wherein said reclining support means consists of one, or a plurality of the following, or equivalent: permanent, or removably-attached forms, or objects, balls, blocks, bags, or figures; including those which are filled, or which are inflatable/expandable; any of which may, or may not articulate.

5. The book or bound materials stabilizing method in claim 1, wherein said reclining support means consists of one, or a plurality of the following, or equivalent: permanent, or removably-attached members, trusses, frames, containers, or panels; including those which are filled, or which are inflatable/expandable; and any of which may, or may not articulate.

6. The book or bound materials stabilizing method in claim 1, which also integrates other components thereto, into a conveniently integrated system; comprising one, or a plurality of page securing means, together with one, or a plurality of members from at least one of the following categories:
(a) a cover stabilizing, or orienting & securing means;
(b) an environmental protective means;
(c) a book carrying (transporting), and/or storage alternative means; and
(d) an alternative display or support means;
whereby the book or bound materials may be suspended from an appropriate support means, such that the viewing plane is supported in a substantially vertical manner.

7. Modifications or alterations, including one, or a plurality of attachment means, or other appropriate interfacing means, made to one or more objects of separate, or independent functional, or utilitarian value, whereby they may readily interact with books, bindings, bookcovers, or cover assemblies, such that when joined thereto, they form a book, or bound materials supporting means, or system which:
(a) provides conveniently stabilization of books, or bound materials, of both lay-flat, and non-lay-flat binding types or configurations; together with the page-viewing plane thereof, and the binding or spinal axis around which pages or leaves are turned, at one, or a plurality of tilted viewing angles from the generally horizontal support surface; of which at least one corresponds to that which is conducive, or is commonly used for normal, or general scholastic, or office desk study posture;
(b) provides a viewing plane more perpendicular to the line-of-sight; and
(c) provides a stabilizing capability spanning approximately half of the width of the cover, or more,
whereby rotational moment forces about the spinal axis, or any deployed spinal strut axis, are counteracted.

8. Modifications or alterations, including one, or a plurality of attachment means, or other appropriate interfacing means, made to books, bindings, covers, or cover assemblies, whether permanent, or removable, whereby they may readily interact with one or more reclining support means, such that when joined thereto, they form a book, or bound materials supporting means, or system:
(a) providing convenient stabilization of books, or bound materials, of both lay-flat, and non-lay-flat binding types or configurations, together with the page-viewing plane thereof, and the binding or spinal axis around which pages or leaves are turned, at a plurality of tilted viewing angles from the generally horizontal support surface; of which at least one corresponds to that which is conducive, or is commonly used for normal, or general scholastic, or office desk study posture;
(b) providing a viewing plane more perpendicular to the line-of-sight; and
(c) providing a stabilizing capability spanning approximately half of the width of the cover, or more,
whereby rotational moment forces about the spinal axis, or any deployed spinal strut axis, are counteracted.

9. Modifications or alterations, including one, or a plurality of attachment means, or other appropriate interfacing means, made to books, bindings, covers, or cover assemblies, whether permanent, or removable, whereby they may readily interact with one or more reclining support means, such that when joined thereto, they form a book, or bound materials supporting means, or system:
(a) providing convenient stabilization of books, or bound materials, of both lay-flat, and non-lay-flat binding types or configurations, together with the page-viewing plane thereof, and the binding or spinal axis around which pages or leaves are turned, at one, or a plurality of tilted viewing angles from the generally horizontal support surface; of which at least one corresponds to that which is conducive, or is commonly used for normal, or general scholastic, or office desk study posture;
(b) providing a viewing plane more perpendicular to the line-of-sight; and
(c) providing a stabilizing capability spanning approximately half of the width of the cover, or more,
whereby rotational moment forces about the spinal axis, or any deployed spinal strut axis, are counteracted.

10. In conjunction with the modifications or alterations in claim 9, wherein the reclining support means articulates from a permanently attached, or removable bookcover surface, which overlays all or part of the original bookcover; said surface, and reclining support means articulating, and being joined therewith by other than a horizontal hinge means along the top edge of the book, or bound materials; and said reclining support means consisting of one, or a plurality of the following, or equivalent: permanent, or removably-attached articulatable flaps, wings, or window-like portions matching the surface profile of the bookcover, or of an integral, or added layer or surface, thereto, or portion thereof.
